(19) United States
(12) Patent Application Publication
(10) Pub. No.: US 2026/0082098 A1
(43) Pub. Date: Mar. 19, 2026

(54) VOICE CONTROL FOR SETTINGS ON TV OR OTHER ELECTRONIC DEVICES

(71) Applicant: Roku, Inc., San Jose, CA (US)

(72) Inventors: Amit Vishvanath Desai, San Francisco, CA (US); Siddhant Dinesh Shah, Santa Clara, CA (US); Tess Harty, San Francisco, CA (US); Elizabeth Owen Bratt, Mountain View, CA (US); Valeria Faria de Sá, Fair Haven, NJ (US); I-Tsun Cheng, San Jose, CA (US); Doo Soon Kim, San Jose, CA (US); Arnaldo Carreno, Leander, TX (US)

(73) Assignee: Roku, Inc., San Jose, CA (US)

(21) Appl. No.: 19/261,126

(22) Filed: Jul. 7, 2025

Related U.S. Application Data
(60) Provisional application No. 63/694,798, filed on Sep. 14, 2024.

(51) Int. Cl. H04N 21/422; H04N 21/431; H04N 21/485

(52) U.S. Cl. CPC H04N 21/42203; H04N 21/4316; H04N 21/485

(57) ABSTRACT

On a television or media device, it is painfully slow for users to click through a settings tree to perform device tasks. To address this issue, a voice-based application can be implemented to help users perform and access device tasks by voice. A user can make an utterance to reach a specific page in the setting tree where the user can then complete the device task. It is not trivial to implement the application. It can be a challenge to determine the precise device task intent from the utterance when there are hundreds of device tasks. The type of device task intent and the context of the user device may impact the way the user interface is to be updated. Some device tasks may be unsupported by the user device. Voice hints to help users learn to use their voice can follow a unique logic for suppressing voice hints.

### RELATED APPLICATIONS

This patent application claims priority to and/or receives benefit from U.S. provisional application No. 63/694,798, titled “VOICE CONTROL FOR SETTINGS ON TV OR OTHER ELECTRONIC DEVICES”, filed on Sep. 14, 2024. The provisional application is hereby incorporated by reference in its entirety.

### TECHNICAL FIELD

This disclosure relates generally to electronic devices, and more specifically, to voice control for settings on television (TV) or other digital/electronic devices.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1A illustrates an entertainment system having a smart television system, according to some embodiments of the disclosure.

FIG. 1B illustrates an entertainment system having a television and a media player system coupled to the television, according to some embodiments of the disclosure.

FIG. 2 illustrates components in a smart television system, according to some embodiments of the disclosure.

FIG. 3 illustrates components in a media player system, according to some embodiments of the disclosure.

FIG. 4 illustrates a voice assistant, according to some embodiments of the disclosure.

FIG. 5 illustrates a device task intent understanding model, according to some embodiments of the disclosure.

FIG. 6 illustrates a voice for device tasks application, according to some embodiments of the disclosure.

FIG. 7 depicts a flow diagram illustrating a method for changing the graphical user interface based on an output of the device task intent understanding model, according to some embodiments of the disclosure.

FIG. 8A depicts a graphical user interface when a user makes an utterance, according to some embodiments of the disclosure.

FIG. 8B depicts a graphical user interface displaying a device task page that corresponds to a detected device task intent of the utterance illustrated in FIG. 8A, according to some embodiments of the disclosure.

FIG. 9A depicts a graphical user interface when a user makes an utterance, according to some embodiments of the disclosure.

FIG. 9B depicts a graphical user interface displaying a device task page that corresponds to a detected device task intent of the utterance illustrated in FIG. 9A, according to some embodiments of the disclosure.

FIG. 10A depicts a graphical user interface when a user makes an utterance, according to some embodiments of the disclosure.

FIG. 10B depicts a graphical user interface displaying options for going to different pages corresponding to different detected device task intents of the utterance illustrated in FIG. 10A, according to some embodiments of the disclosure.

FIG. 11 depicts a flow diagram illustrating a method for changing the graphical user interface based on a context of the user device, according to some embodiments of the disclosure.

FIG. 12 depicts a graphical user interface displaying a device task page overlay, according to some embodiments of the disclosure.

FIG. 13 depicts a flow diagram illustrating a method for changing the graphical user interface based on a context of the user device, according to some embodiments of the disclosure.

FIG. 14 depicts a graphical user interface displaying a yes option and a no option, according to some embodiments of the disclosure.

FIG. 15 depicts a graphical user interface displaying device task page in the third-party media application, according to some embodiments of the disclosure.

FIG. 16 depicts a graphical user interface displaying a yes option and a no option, according to some embodiments of the disclosure.

FIG. 17 depicts a flow diagram illustrating a method for changing the graphical user interface based on a context of the user device, according to some embodiments of the disclosure.

FIG. 18 depicts a graphical user interface displaying an error message, according to some embodiments of the disclosure.

FIG. 19 depicts a flow diagram illustrating a method for changing the graphical user interface based on a context of the user device, according to some embodiments of the disclosure.

FIG. 20 depicts a graphical user interface displaying an error message, according to some embodiments of the disclosure.

FIG. 21 depicts a flow diagram illustrating a method for handling one or more unsupported device tasks, according to some embodiments of the disclosure.

FIG. 22 depicts a graphical user interface displaying an error message, according to some embodiments of the disclosure.

FIG. 23 depicts a graphical user interface displaying an error message, according to some embodiments of the disclosure.

FIG. 24 depicts a flow diagram illustrating a method for managing voice hints, according to some embodiments of the disclosure.

FIG. 25 depicts a graphical user interface displaying a message having a voice hint, according to some embodiments of the disclosure.

FIG. 26 depicts a flow diagram illustrating a method for enabling users to use voice to assist in performing device tasks, according to some embodiments of the disclosure.

FIG. 27 is a block diagram of an exemplary computing device, according to some embodiments of the disclosure.

### DETAILED DESCRIPTION

### Overview

Offering the best voice companion for TV watchers can result in compelling and indispensable experience for end users. The voice-based application and the features provided by the application aims to achieve one or more success factors: value, friction, and discovery. User value is added when using voice is better than using a remote. Voice is faster. Voice is easier. Voice can do more. Voice can bring delight. The technical task is to offer a voice-based application where end users can talk to the device to help the end user do any device task. A device task can be referred to as a settings task or a settings-related task. A user can make an utterance when the user intends to perform a particular device task, and the voice-based application can recognize a device task intent based on the utterance and assist the user accordingly.

Device tasks encompass scenarios where users want to do something with a number of device settings and features of a TV or a media device. Examples of device tasks and an illustrative voice utterance that corresponds to a device task may include:

| Device Task | Voice |
|---|---|
| Screensaver | “change the screensaver” |
| Wallpapers | “change the wallpaper” |
| Parental Controls | “turn on Parental Controls” |
| Network Connection | “check Internet connection strength” |
| System Restart | “check if there is an update available” |
| Audio Guide (Screen Reader) | “turn off Screen Reader” |
| Guest Mode | “turn on Guest Mode” |
| Payment Info | “see the credit card on file” |
| Screen Mirroring | “learn how to screencast” |
| System Language | “change the system language” |

A TV or media device can have one or more navigation menus that lets users perform device tasks. Users can click through a hierarchy of pages to reach a page to perform or find a device task. A navigation menu can have a settings tree or a task tree, which represents how pages are organized or arranged in the navigation menu. A click to expand a node of the tree can allow the user to go deeper into the tree. A user can go up a level to reach a higher level of the tree. Sometimes a settings tree or task tree can have many leaf nodes. Sometimes a settings tree or task tree can be 3-4 levels deep. An exemplary settings tree or task tree (or a portion thereof) is as follows:

```
1. Settings
  1.1 System
    1.1.1 About
      1.1.1.1 Network name, Email address, Software version
    1.1.2 ZIP Code
    1.1.3 Time
      1.1.3.1 Sleep timer
      1.1.3.2 Time zone
      1.1.3.3 Clock format
    1.1.4 Power
      1.1.4.1 Power on home screen versus power on last used TV input
      1.1.4.2 Auto-power settings
      1.1.4.3 Standby Light-Emitting Diode
      1.1.4.4 System restart
    1.1.5 Guest Mode
      1.1.5.1 Enter guest mode
    1.1.6 Advanced system settings
      1.1.6.1 Factory reset
        1.1.6.1.1 Reset TV audio/picture settings
        1.1.6.1.2 Factory reset everything
      1.1.6.2 Network connection reset
      1.1.6.3 Device connect
      1.1.6.4 Control by mobile applications
        1.1.6.4.1 Network access
```

Using a remote to perform device tasks, e.g., to access information for screensavers, remote devices, system information, guest mode, etc., can be cumbersome. Users don't remember exactly where a setting is found in the hierarchy. On a TV or media device, it is painfully slow for users to click through a settings tree to perform device tasks (even when location is known). The settings tree or task tree can be several levels deep and can have 100+ pages as leaves of the tree. End users may find the experience of using a remote to perform device tasks very frustrating, slow, difficult, and unsatisfactory. In one usability study, participants were given several device tasks to perform. Some device tasks resulted in failure (user was unable to perform a given task). Some device tasks resulted in indirect success (user completed task after mis-steps and correction). Despite frustration, the settings menu has high usage (a significant portion of monthly users enter the settings via left hand navigation). Consumer survey results reveal that there is high user interest in voice control of settings.

To address this issue, a voice-based application can be implemented to help users perform and access device tasks by voice, instead of painfully clicking through the settings tree. A user can make an utterance to reach a specific page in the settings tree where the user can then complete the device task. The utterance representing a voice command can be captured using a voice-enabled remote, a mobile/smartphone application, etc. Doing those device tasks using voice can become much easier, faster, and simpler for end users. The voice-based application can delight users with a far superior experience for performing tasks and accessing settings. Voice enablement can increase engagement with their TVs and media devices.

Preferably, the voice-based application does not execute the device task (e.g., change the setting or execute a command that changes the setting). Instead, the relevant page (or screen) to perform or find the device task is opened or displayed on screen. As a result, the user can directly go to a desired settings or task page of the settings tree or task tree. The user can continue, such as to perform the device task on the desired settings/task page, using the remote. The deliberate decision to navigate the user to the relevant page to complete the device task instead of directly changing the setting can allow errors caused by the natural language processing model misinterpreting or not comprehending the user's utterance accurately due to ambiguity in human language to fail more gracefully. It is not a huge hinderance to the user to perform a last click or two using a remote to complete the device task, in comparison to the work involved in finding and navigating to the relevant page through a complex tree.

It is not trivial to implement the application. One insight is that possible device tasks can each be mapped to a particular page in a settings tree or task tree where the device task can be performed or found. A task set is predefined to have a list of the possible device tasks, or device task intents. The list of possible device task intents may include an exhaustive list of tasks relating to settings/features of a TV or media system that the user may want to perform. A destination page set is predefined to include possible device task pages which can be a valid destination for a task in the task set. A page may include a specific screen/leaf in the settings tree or task tree. The page may further include a focus state where a certain part of the screen is highlighted. A set of deep links is predefined. The set of deep links maps different device task intents of the task set to different device task pages in the page destination set. The following table illustrates an example of deep links, which includes a mapping of device task intents to destination device task pages:

| Deep link | Device task intent | Destination device task page |
|---|---|---|
| 1 | Parental control | Page 6 |
| 2 | Screensaver | Page 10 |
| 3 | Wallpaper | Page 10 |
| 4 | Remotes | Page 26 |
| 5 | . . . | . . . |

For each deep link or device task intent, a voice path may be predefined, which deep links a device task intent to the page. The voice path may include one or more corresponding or associated voice interactions, phrases, or utterances, or one or more representative voice interactions, phrases, or utterances. An example utterance for a voice path for a parental control device task intent may include, “parental control”. While a voice path may have representative utterances, the natural language processing model implemented in the device task intent understanding model used to determine the device task intent from the uttered text can robustly understand human language. This is because a large language model is used to produce many variations of the representative utterances that correspond to the same device task intent, and the variations along with the representative utterances are used as training data to train the natural language processing model. Because of the training process, the natural language processing model is able to comprehend and understand device task intent beyond the representative utterances.

For each deep link, device task intent, or destination page, a corresponding or associated message or response may be predefined. The message or response may be displayed or output to the user when the user is navigated to the destination page, e.g., via the voice path. An example message/response for destination page where the parental control device task intent may be performed or found can include, “Here's the setting for Parental Control”.

Deep links may include one or more valid paths, where if a user says a representative utterance corresponding to the device task intent, the destination device task page corresponding to the device task intent is shown, and optionally the corresponding/associated message or response corresponding to the device task page is shown. For example, if a user says “wallpapers” and a wallpaper device task intent is detected, the settings page for changing wallpapers corresponding to the wallpaper device task is displayed and a message corresponding to the page having “Here's the setting for Wallpapers” is displayed.

It can be a challenge to determine the precise device task intent from the utterance when there are hundreds of device tasks. In addition, the voice of a user can be used for other types of tasks, such as changing a channel, and content retrieval or search. A device task intent understanding model may be part of a federation of models that processes text produced from audio. The device task intent understanding model has a technical task to robustly comprehend or understand device task intent in the task set, or phrased differently, be able to accurately classify or disambiguate between the different device task intents in the task set. The device task intent understanding model may rank different device task intents based on confidence level or output different confidence levels for the different device task intents in the task set. An intent fulfillment router can handle or arbitrate conflicts between device task intents and other intents to allow voice to be used for a variety of intents. In some cases, if there is intent ambiguity, the router can make the best choice across the different types of intents based on the context of the user device.

In some embodiments, the device task intent understanding model may include a natural language processing model that is trained or prompted based on corresponding/associated voice interactions, phrases, or utterances of different voice paths. To produce training data, a large language model is used to produce variations based on the one or more representative voice interactions to capture a variety of different ways to express the same device task intent. The natural language processing model may include a deep learning model able to receive audio and/or text converted from the audio to output probabilities for different device task intents, or one or more detected device task intents having the highest probabilities. The produced variations along with the corresponding/associated voice interactions, phrases, or utterances, are used as training data to train the natural language processing model to classify and extract the device task intent from the text spoken by the user. The training using the representative utterances and generated variations corresponding to different voice paths can enable the device task intent understanding model to detect device task intents even when a user may utter words which are different but may have the same semantic meaning or intent. In some embodiments, the device task intent understanding model produces an output that may indicate confidence levels of different device task intents detected for a user utterance, which may allow the voice application to strategically handle possible ambiguities and overlap between the many possible device task intents in the task set. If the output of the device task intent understanding model is not sure or certain which device task intent was intended by the user, the user may be offered multiple options. Offering the options to the user instead of acting upon the device task intent with the highest probability can avoid causing user frustration, since users can get frustrated when a wrong page is displayed that does not match the intended device task intent.

In some embodiments, the voice-based application includes different manners to change the user interface to support different ways to respond to a user's utterance. Properly provisioned user interface behaviors can prevent jarring user experience and unintended changes to the user device. Properly provisioned user interface behaviors can preserve logic required for third-party applications. The type of device task intent and the context of the user device may impact the way the user interface is to be updated. A device task intent may belong to different types, including: unique to the third-party media application in playback mode, found in both an operating system task tree and an overlay task tree, unique to the operating system task tree, and unique to the overlay task tree. The user device may be in one of different contexts, including: playback in native media player, in third-party media application but not in playback, in third-party media application and in playback, in native user application, and in electronic program guide. In some cases, the native user application is implemented on a television and is pre-installed on the television before a user first uses the television. In some cases, the native user application is implemented on a media device and is pre-installed on the television before a user first uses the television.

In some cases, the task set can include device task intents that are supported by a television and/or a media device. This means that in some cases, a device task intent may not be supported by a user device. In some cases, a device task intent may be supported by a television and a media device. A device task intent may be supported only by a television and not by a media device. A device task intent may be supported only by a media device and not by a television. When one or more detected device task intents is unsupported by the user device, a suitable error message may be displayed to the user.

Voice hints are displayed to help users learn the voice-based application. Voice hints refer to displaying or outputting a message that helps users learn that voice can be used for performing a device task. User interactions through a native user application can be tracked to determine whether the user interaction matches a manual navigation path (using a remote) to a destination page in the destination page set. Upon detecting that the user has navigated to the destination page through the settings tree or task tree and optionally performs the device task on the destination page, a voice hint may be displayed to the user. If voice hints are displayed at times which are not relevant, voice hints are not effective. Overuse of voice hints can also be ineffective, annoying, and ignored. To make the voice hints more effective, the generation and display of voice hits may follow a unique logic for displaying and suppressing voice hints.

### Exemplary Entertainment Systems

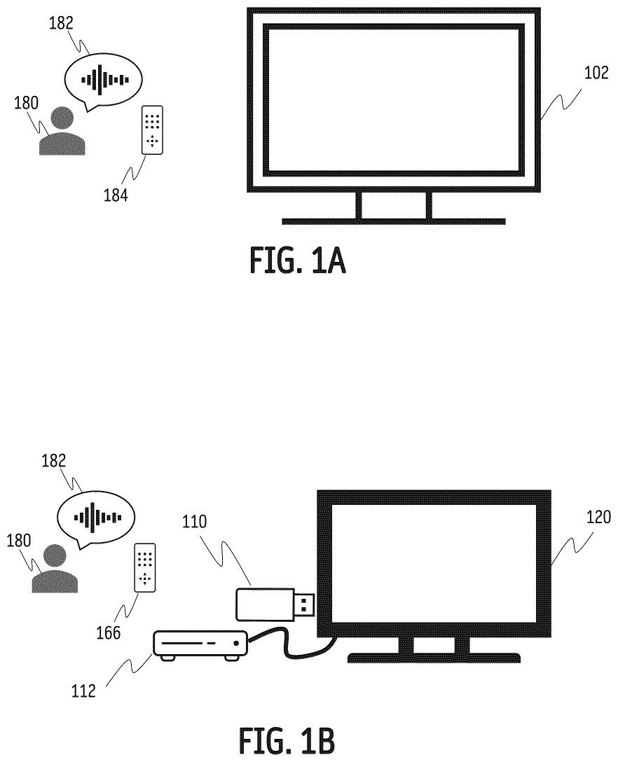

FIG. 1A illustrates an entertainment system having a smart television system 102, according to some embodiments of the disclosure. Smart television system 102 may include output systems such as display system and audio system to output multimedia content to user 180. Smart television system 102 may be a smart TV system, meaning that smart television system 102 can include compute electronics and interactive applications implemented thereon to offer advanced multimedia and interactive experiences. In addition, smart television system 102 may have Internet connectivity to stream high-resolution content.

User 180 may control smart television system 102 using remote device 184. Remote device 184 may be a remote controller (e.g., a handheld electronic device having buttons thereon). Remote device 184 may wirelessly transmit commands to smart television system 102. Remote device 184 may be a smartphone having a remote controller application implemented thereon. Remote device 184 may be a wearable device (e.g., glasses, googles, watch, etc.) having a remote controller application implemented thereon. User 180 may control smart television system 102 using buttons provided with remote device 184. User 180 may control smart television system 102 using voice by making an utterance 182. Remote device 184 may include a microphone to capture audio signals that has the voice of user 180. In some cases, smart television system 102 may include a microphone to capture audio signals that has the voice of user 180. Remote device 184 may include a gyroscope and/or accelerometer (or the like) to capture signals capturing movement or gestures of user 180.

FIG. 1B illustrates an entertainment system having television 120 and a media player system coupled to the television, according to some embodiments of the disclosure. The entertainment system may include television 120. Television 120 may include such as display system and audio system to output multimedia content to user 180. A media player system, e.g., player 110 or player 112, may be coupled to television 120. The media player system can include compute electronics and interactive applications implemented thereon to offer advanced multimedia and interactive experiences. In addition, the media player system may have Internet connectivity to stream high-resolution content. Different media player systems may have different form factors and functionalities. For instance, player 110 may be powered by television 120, and has a compact form factor. Player 112 may have a less compact form factor and may receive power from a different source. Player 112 may have larger compute electronics and/or more compute electronics to offer more functionalities. In some cases, television 120 is a smart television system.

User 180 may control smart television system 102 and/or a media player system (e.g., player 110 or player 112) using remote device 166 (e.g., a handheld electronic device having buttons thereon). Remote device 166 may wirelessly transmit commands to the media player system. Remote device 166 may be a remote controller. Remote device 166 may be a smartphone having a remote controller application implemented thereon. Remote device 166 may be a wearable device (e.g., glasses, googles, watch, etc.) having a remote controller application implemented thereon. User 180 may control smart television system 102 and/or a media player system using buttons provided with remote device 166. User 180 may control smart television system 102 and/or a media player system using voice by making an utterance 182. Remote device 166 may include a microphone to capture audio signals that has the voice of user 180. In some cases, the media player system 302 may include a microphone to capture audio signals that has the voice of user 180. Remote device 166 may include a gyroscope and/or accelerometer (or the like) to capture signals capturing movement or gestures of user 180.

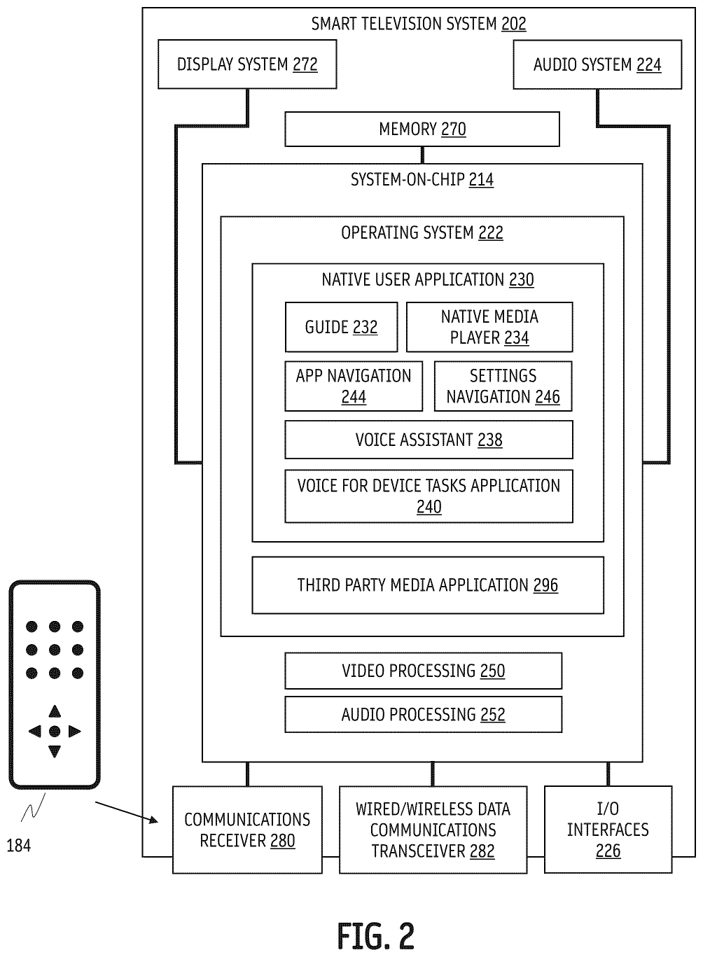

FIG. 2 illustrates components in smart television system 202, according to some embodiments of the disclosure. Smart television system 202 illustrates components of smart television system 102 of FIG. 1A.

Smart television system 202 may include one or more output systems such as display system 272 and audio system 224. Display system 272 may include a display panel, such as a liquid crystal display (LCD) display panel, a light-emitting diode (LED) display panel, an organic light-emitting diode (OLED) display panel, a quantum dot light-emitting diode (QLED) display panel, a mini-LED display panel, a microLED display panel, etc. Audio system 224 may include one or more speakers.

Smart television system 202 includes system-on-chip 214 and memory 270 coupled to system-on-chip 214. System-on-chip 214 can perform core compute functionalities for smart television system 202 and serves as the primary computational engine. System-on-chip 214 can integrate multiple functional blocks, including graphics processing, video decoding, network interface management, and operating system execution. System-on-chip 214 may include one or more hardware logic blocks such as video processing 250 (e.g., implementing graphics processing algorithms and/or video codecs) and audio processing 252 (e.g., implementing audio signal processing algorithms and/or audio codecs). Memory 270 may store instructions that can be executed by system-on-chip 214. Memory 270 may store data to support functionalities of system-on-chip 214. Memory 270 may store configuration data for system-on-chip 214.

Smart television system 202 may include one or more input/output (I/O) interfaces 226, such as physical ports and connectors to receive input data and/or transmit output data to external devices. Examples of physical ports may include High Definition Multimedia Interface (HDMI) ports, Universal Serial Bus (USB) connection, optical audio port, audio jacks, etc. Smart television system 202 may include wired/wireless data communications transceiver 282 to receive and transmit data from a data network, such as a local network or the Internet. Examples of data communications transceivers may include Ethernet transceiver, Bluetooth transceiver, Wi-Fi transceiver, Zigbee transceiver, etc. Smart television system 202 may include communications receiver 280, such as a near field communication transceiver, Bluetooth transceiver, Wi-Fi direct receivers, Zigbee receivers, optical sensor, infrared sensor, etc., to receive commands and/or audio signals from remote device 184. Smart television system 202 may include additional circuitry not depicted explicitly, such as circuitry for power management, circuitry for network interface management, driver circuitry, voltage regulation circuitry, circuitry for memory management, analog-to-digital converters, digital-to-analog converters, etc.

System-on-chip 214 can implement operating system 222. Operating system 222 may include software to manage components of smart television system 202 and provide a user interface for which a user can interact with smart television system 202. Operating system 222 implements functionalities that transform display system 272 and/or audio system 224 into comprehensive multimedia and interactive computing platforms. Operating system 222 may include core system software that manages the hardware components on smart television system 202. The core system software may include a bootloader, initialization process, kernel modules, file system manager, system libraries, memory manager, and device drivers. The core system software may include a networking stack. The core system software may include graphics and display management. The core system software may include power management processes. In addition, the core system software includes an application layer that can support a number of user applications. The application layer may include an application store that allows one or more user applications to be installed and run by operating system 222.

Operating system 222 may implement native user application 230 (e.g., native user application 230 (and parts thereof) may be pre-installed or included as part of operating system 222) that serves as the primary user interface with a user and can offer an initial set of functionalities for the user. The functionalities may include allowing a user to browse and/or search for content, allowing a user to perform device tasks, allowing a user to browse and/or search for applications, allowing a user to view media content, etc.

Native user application 230 may include guide 232. Guide 232 may be an electronic program guide (EPG). Guide 232 can include a graphical user interface displayed on a display screen that provides users with comprehensive information about current and upcoming television programs and content. Guide 232 allows users to browse channel listings, view program details like show descriptions and air times, search for specific content. Guide 232 can includes features such as scheduling recordings, setting reminders, and receiving personalized program recommendations. In some cases, guide 232 may include a graphical user interface displayed on a display screen that provides users with a visually rich, horizontally scrolling grid of content thumbnails organized by genres, recommendations, and categories like “Trending Now” or “Because You Watched.” Each content tile displays a cover image, brief title, rating, and genre indicators, allowing users to quickly browse and select movies or shows through intuitive navigation using arrow keys or mouse/touch interactions, with additional hovering functionality that provides more information and quick-play options.

Native user application 230 may include native media player 234. Native media player 234 can include a graphical user interface for playing digital audio and video content, featuring playback controls like play, pause, rewind and fast forward. The graphical user interface may include a progress bar for navigating within the duration of the content. Native media player 234 can include support for various file formats.

Native user application 230 may include application navigation 244. Application navigation 244 can include a graphical user interface having a grid of tiles/icons representing applications which are installed on operating system 222. Application navigation 244 allows a user to browse and/or search for applications and launch an application by clicking or selecting a tile/icon.

Native user application 230 may include settings navigation 246. Settings navigation 246 can include a graphical user interface with different pages organized as a settings tree or task tree (or similar hierarchical grid or list format). Settings navigation 246 allows a user to click through the tree to perform a device task. Settings navigation 246 can include an interface for customizing, e.g., display, audio, network, and system preferences. Users can use settings navigation 246 to perform a variety of device tasks, such as adjust picture settings like brightness, contrast, and color modes, modify sound output, configure network and accessibility options, manage input sources, set parental controls, and update system software, using remote device 184 and/or an on screen cursor.

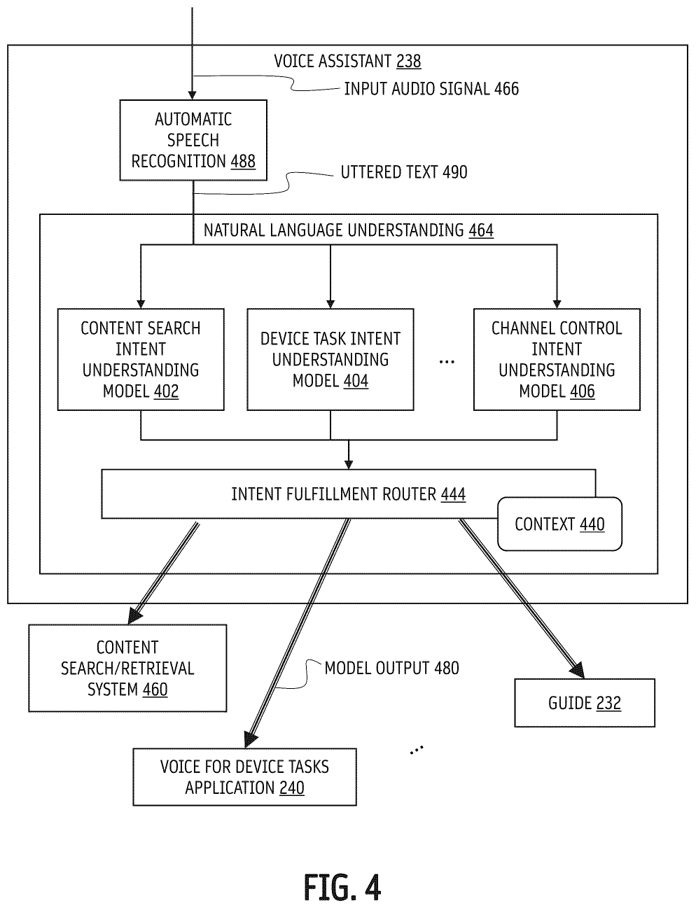

Native user application 230 may include voice assistant 238. Voice assistant 238 can include a digital interface that utilizes automatic speech recognition and natural language processing to understand and execute verbal commands, enabling users to interact with smart television system 202 (or other devices on which voice assistant 238 is implemented) through spoken utterances having instructions. In some cases, voice assistant 238 can include one or more models that can extract the intent of the user's utterance. Voice assistant 238 can trigger tasks to be executed in response to user utterances. Exemplary tasks can include searching content, launching an application, selecting a channel, setting reminders, etc. In some cases, voice assistant 238 can answer questions or queries spoken by users by leveraging artificial intelligence and cloud-based processing to interpret and respond to human speech in real-time. An exemplary implementation of voice assistant 238 is illustrated in FIG. 4.

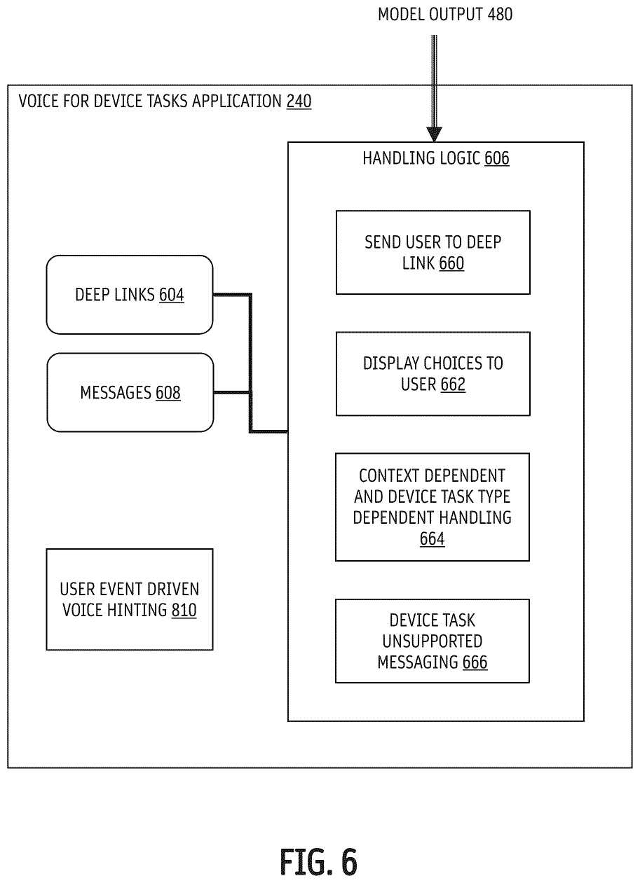

Native user application 230 may include voice for device tasks application 240. Voice for device tasks application 240 can take an output from a model that can extract device task intents from users' utterances and adjust the graphical user interface of smart television system 202 (or other devices on which voice for device tasks application 240 is implemented) according to the output. An exemplary implementation of voice for device tasks application 240 is illustrated in FIG. 6.

Operating system 222 may implement third-party media application 296 that serves as an additional application that a user may interact with. Third-party media applications may be managed and implemented by a different company that implements operating system 222 and native user application 230. Third-party media application 296 can in some cases be pre-installed or may be installed on operating system 222 upon user request.

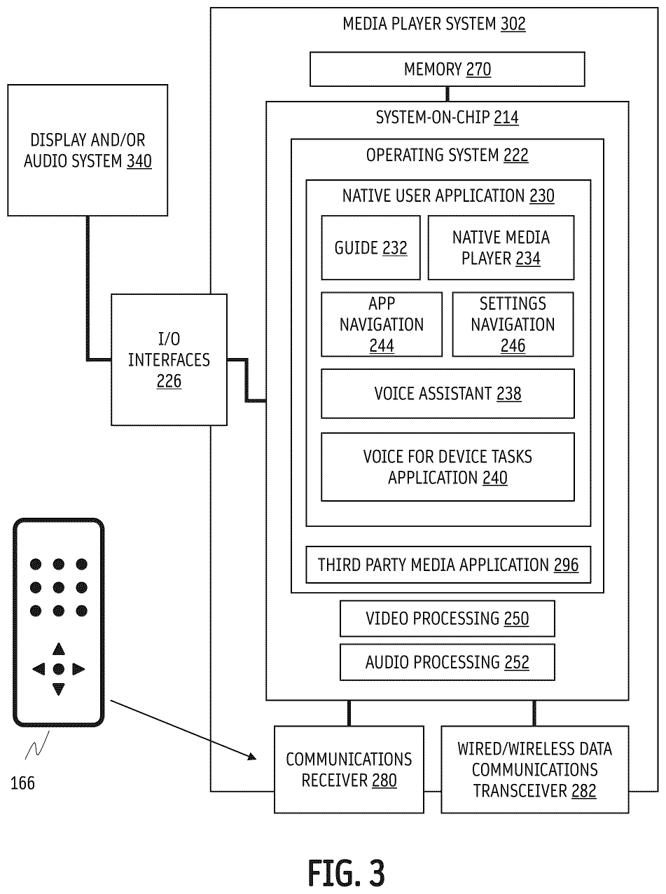

FIG. 3 illustrates components in media player system 302, according to some embodiments of the disclosure. Media player system 302 illustrates components of media player system 302 of FIG. 2. Media player system 302 includes same and/or similar components of smart television system 202, with the exception that display and/or audio system 340 is external to media player system 302 and coupled to media player system 302 via one or more input/output interfaces 226. In some cases, display and/or audio system 340 may be coupled to media player system 302 via wired/wireless data communications transceiver 282. Media player system 302 may be controlled using remote device 166.

### Exemplary Voice Assistant

FIG. 4 illustrates voice assistant 238, according to some embodiments of the disclosure. Voice assistant 238 may include automatic speech recognition 488 and natural language understanding 464. Voice assistant 238 can serve as an interface between audio capturing a user utterance and a downstream processing component that can fulfill the intent of the user utterance.

Automatic speech recognition 488 may include an acoustic model and a language model. Automatic speech recognition 488 can turn audio signals, e.g., input audio signal 466 into natural language text, e.g., uttered text 490. Input audio signal 466 may be generated by a microphone in a remote device. The acoustic model may map audio features extracted from the audio signal into phonetic representations. Exemplary acoustic models may include Gaussian Mixture Models, Deep Neural Networks, and Hidden Markov Models. The acoustic model may account for variability in speech due to accents, speaking rates, background noise, etc. The language model may estimate probabilities of sequences of words or phrases based on the output of the acoustic model. Exemplary language models may include N-gram models, neural network language models, and maximum entropy models. Automatic speech recognition 488 may receive input audio signal 466, process input audio signal 466, and produce uttered text 490 representing one or more words uttered by a user, such as a user speaking a command using a remote device.

Voice assistant 238 may include natural language understanding 464. Natural language understanding 464 may receive natural language text (e.g., uttered text 490 from automatic speech recognition 488), process the natural language text, and determine one or more intents associated with the natural language text. In some embodiments, natural language understanding 464 may include one or more (artificial intelligence or machine learning based) intent understanding models to interpret the natural language text and produce structured representation of the natural language text. A machine learning based intent understanding model can leverage prior knowledge about human language to extract nuances and resolve ambiguity in the natural language text when producing the structured representation. A machine learning based intent understanding model can analyze natural language text to determine the user's underlying purpose or goal, interpret context, extract semantic meaning, and classify the intended action or request across complex linguistic variations. A machine learning based intent understanding model can enable more accurate and contextually relevant responses in voice-based interactions. A machine learning based intent understanding model can include neural network models (e.g., convolutional neural networks, recurrent neural networks, long short-term memory networks, transformer-based neural networks, etc.), classification models (e.g., support vector machines, naïve Bayes model, random forest models, gradient boosting classifiers, etc.), and natural language processing models (e.g., word embedding models, contextual embedding models, semantic parsing models, etc.). It is envisioned that an intent understanding model may not be machine learning based, but instead, the intent understanding model may include natural language processing algorithms designed based on explicit linguistic patterns and keywords.

One challenge to enabling a user to use voice to perform device tasks is that voice is also used for performing other tasks, such as content searching, and channel control. To tackle this challenge, a federation of models is included in natural language understanding 464 to process the natural language text. The federation of models can include models trained, configured, and designed for different intent extraction tasks/contexts. The federation of models can include content search intent understanding model 402, device task intent understanding model 404, and channel control intent understanding model 406. The federation of models may operate in parallel to produce outputs independently, and the outputs may be provided to intent fulfillment router 444. A federation of models having specialized models for extracting different types of intents enable the models to collaboratively analyze linguistic inputs, and intent fulfillment router 444 can dynamically route and arbitrate intent predictions based on context 440. As a result, natural language understanding 464 can achieve superior comprehension and interpretation of voice-based utterances that can be used to perform a variety of tasks.

Content search intent understanding model 402 may produce a probability that indicates whether the uttered text 490 represents a content search query (as opposed to other intents). Content search intent understanding model 402 may produce structured representation of a content search query (e.g., a query string, or a content search intent and one or more entities associated with the content search intent). An example of a query string may include, “{“query”: {“type”: “content_search”, “parameters”: {“genre”: [“science fiction”, “drama” ], “release_year”: {“min”: 2020, “max”: 2024}, “rating”: {“min”: 7.5}, “language”: “English”, “runtime”: {“max”: 120}}, “sort_by”: “popularity”, “limit”: 10}}. An example of a content search intent and one or more entities may include, intent=video.request, and entities=VIDEO_GENRE>comedy, ACTOR>Sienna Castillo.

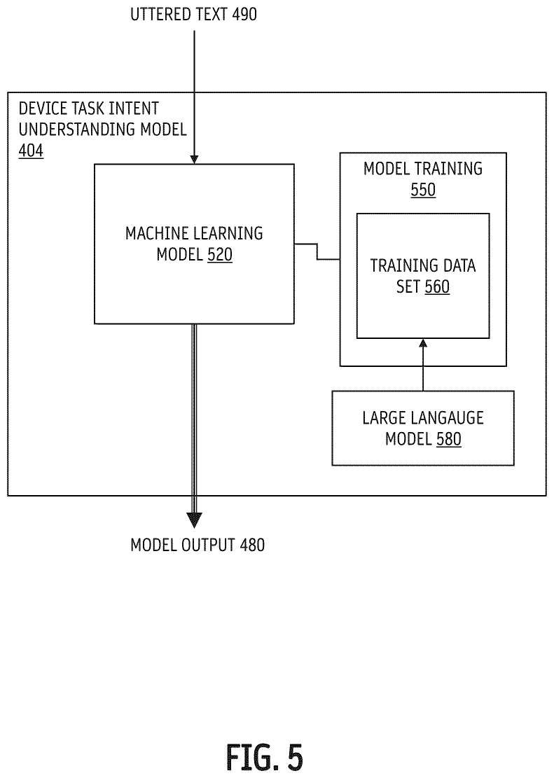

Device task intent understanding model 404 may produce a probability that indicates whether the uttered text 490 represents a device task intent (as opposed to other intents). Device task intent understanding model 404 may produce an output having one or more detected device task intents. In some cases, the output may include or indicate one or more confidence levels corresponding to the one or more detected device task intents. Content search intent understanding model 402 may produce an output having a probability that indicates whether the uttered text 490 corresponds to a single device task intent. Content search intent understanding model 402 may produce an output having a probability that indicates whether the uttered text 490 corresponds to different device task intents. An exemplary implementation of device task intent understanding model 404 is illustrated in FIG. 5.

Channel control intent understanding model 406 may produce a probability that indicates whether the uttered text 490 represents a channel control command (as opposed to other intents). Channel control intent understanding model 406 may produce an output having one or more detected destination channels and (optionally) one or more confidence levels associated with the one or more detected destination channels.

To further address the challenge that voice is used for a variety of intents, intent fulfillment router 444 may receive outputs from the models, and determine a downstream application based on the outputs of the plurality of models and context 440 of a user device. Intent fulfillment router 444 may perform arbitration and resolve potential conflicting outputs from the model based on context 440. Context 440 may be used to compute conditional probabilities/likelihoods that uttered text 490 represents a particular type of intent (e.g., content search intent, device task intent, channel control intent). Conditional probabilities/likelihoods can be computed based on one or more confidence levels produced by the federation of models, and context 440. Context 440 may include a state of the user device, profile information about the user, information about time and seasonality, historical state of actions taken on the user device, etc. In some embodiments, intent fulfillment router 444 may apply one or more rules or logic based on one or more confidence levels produced by the federation of models, and context 440 to determine the specific type of intent. Given context 440, intent fulfillment router 444 can determine whether uttered text 490 represents a specific type of intent.

Based on the determined type of intent, intent fulfillment router 444 can determine the model that corresponds to the type of intent. For example, if the type of intent is content search intent, the corresponding model is the content search intent understanding model 402. If the type of intent is device task intent, the corresponding model is device task intent understanding model 404. If the type of intent is channel control intent, the corresponding model is channel control intent understanding model 406.

Intent fulfillment router 444 can determine the downstream application that corresponds to the specific type of intent as well. For example, if the type of intent is content search intent, the corresponding downstream application is content search/retrieval system 460. If the type of intent is device task intent, the corresponding downstream application is voice for device tasks application 240. If the type of intent is channel control intent, the corresponding downstream application is guide 232.

Intent fulfillment router 444 can route the output from a corresponding model in the federation of models to a corresponding downstream application. In response to determining the downstream application is content search/retrieval system 460, intent fulfillment router 444 can route the output from content search intent understanding model 402 to content search/retrieval system 460. Content search/retrieval system 460 can receive a search query, execute the search query, and return one or more matching content items to the user. In response to determining the downstream application is voice for device tasks application 240, intent fulfillment router 444 can route the output from device task intent understanding model 404 (e.g., model output 480) to voice for device tasks application 240. Device task intent understanding model 404 can respond accordingly to model output 480. In response to determining the downstream application is guide 232, intent fulfillment router 444 can route the output from channel control intent understanding model 406 to guide 232. Guide 232 can change a current channel to a destination channel in the output from channel control intent understanding model 406.

### Exemplary Device Task Intent Understanding Model

FIG. 5 illustrates device task intent understanding model 404, according to some embodiments of the disclosure. Device task intent understanding model 404 can include machine learning model 520. Machine learning model 520 may receive uttered text 490 and generate model output 480. Machine learning model 520 may include a deep learning model to perform intent classification, specifically, device task intent classification. Machine learning model 520 can be trained by model training 550 to process and understand complex patterns in natural language. Examples of machine learning model 520 include: Recurrent Neural Networks (RNNs), Long Short-Term Memory (LSTM) networks, Convolutional Neural Networks (CNNs), transformer-based models such as Bidirectional Encoder Representations from Transformers (BERT) and Generative Pre-trained Transformer (GPT). Once trained by model training 550, machine learning model 520 can interpret uttered text 490 to extract a device task intent.

One technical challenge for device task intent understanding model 404 is that device task intent understanding model 404 has to be able to accurately distinguish or disambiguate between hundreds of device task intents. As discussed previously, a task set can include hundreds of device task intents. Some may overlap or be similar with each other. Device task intent understanding model 404 is implemented to be able to robustly handle a large task set and to be able to handle situations where uttered text 490 may correspond to a number of different detected device task intents.

One initial technical task is to define voice paths, e.g., representative utterances, that correspond to different device task intents in the task set. The following table illustrates different device task intents and examples of representative utterances that correspond to the device task intents:

| Device Task Intent | Representative Utterances |
|---|---|
| Settings | “Roku settings” |
| | “Roku settings” |
| | “Settings” |
| | “settings on Roku” |
| | ‘change settings’ |
| Network settings | “Network settings” |
| Network name | “Network name” |
| | “what's my Wi-Fi” |
| | “wireless connection” |
| | “what Wi-fi am i on” |
| | “Internet connection” |
| Status | “Connection status” |
| Signal Strength | “Signal strength” |
| | “is something wrong with my Internet” |
| | “is my Wi-Fi good” |
| | “why is my Internet slow” |
| IP address | “IP address” |
| Wireless MAC address | “MAC address” |
| Check connection | “Test Internet connection” |
| | “check Internet” |
| | “how fast is my Internet” |
| | “Internet speed” |
| | “download speed” |
| Connect to Internet | “Change Wi-Fi” |
| | “connect to Internet” |
| | “connect to different network” |
| | “set up wired connection” |
| Remotes & devices | “Remotes & devices” |
| | “remotes” |
| | “Roku devices” |
| Hands-free voice | “Hands-free settings” |
| | “turn on Hey Roku” |
| | “enable hands-free voice” |
| | “Is hands-free turned on?” |
| | “how to turn off Hey Roku” |
| Add new remote | “Add new remote” |
| | “pair remote” |
| | “pair voice remote pro” |
| | “add new Roku remote” |
| | “connect new remote” |
| Speakers | “Speaker settings” |
| Add new speaker | “Add new speaker” |
| Soundbar | “Soundbar settings” |
| Soundbar About | “Soundbar details” |
| Soundbar Restart | “Restart my soundbar” |
| Soundbar Factory reset | “Factory reset soundbar” |
| <Rear left> speaker | “Rear left speaker settings” |
| <Rear left> speaker About | “Rear left speaker details” |
| <Rear left> speaker Restart | “Restart my Rear left speaker” |
| <Rear left> speaker Factory Reset | “Factory reset my Rear left speaker” |
| Subwoofer | “Subwoofer settings” |
| Subwoofer About | “Subwoofer details” |
| Subwoofer Restart | “Restart my Subwoofer” |
| Subwoofer Factory Reset | “Factory reset my Subwoofer” |
| Wireless headphones | “Wireless headphones” |
| Add new wireless headphones | “Add new wireless headphones” |
| Smartphones and tablets | “Smartphone settings” |
| Add new smartphone or tablet | “Add new smartphone” |
| Add device | “Setup new device” |
| Wallpapers & Screensavers OR | “Wallpapers & Screensavers” |
| Theme | “themes” |
| Theme packs | “Change theme pack” |
| | “change theme” |
| Wallpapers | “Change wallpapers” |
| | “set background” |
| | “change wallpaper to Roku City” |
| Screensaver | “Change screensaver” |
| | Names of Roku screensavers, e.g., “Roku City”, “Aquarium” |
| | “Change screensaver to Aquarium” |
| Sounds | “Change sound effects” |
| | “change menu sounds” |
| | “Change sound pack” |
| Screensaver start time | “Turn off screensaver” |
| | “change screensaver to 10 minutes” |
| | “start screensaver after 15 minutes” |
| Default theme | “set default theme” |
| | “reset theme” |
| | “reset wallpaper” |
| | “reset screensaver” |
| Display Type | “Change display resolution” |
| | “change to 1080p” |
| | “set to 4k” |
| Accessibility Settings | “Accessibility settings” |
| | “go to Accessibility” |
| Select captions language | “Change captions language to Spanish” |
| | “change subtitles to French” |
| | “turn on English subtitles” |
| | “set closed caption language to German” |
| Change captions style | “Make caption bigger” |
| | “increase captions size” |
| | “make subtitles smaller” |
| | “change subtitle color” |
| | “customize closed captions style” |
| Screen reader | “Screen reader settings” |
| | “turn on audio guide” |
| | “how to turn off screen reader” |
| Speech rate | “Speech rate settings” |
| | “customize screen reader” |
| | “set screen reader to 2x speed” |
| | “make audio guide faster” |
| Screen reader volume | “increase screen reader volume” |
| | “make audio guide louder” |
| Screen reader pitch | “increase screen reader pitch” |
| | “set audio guide to a higher pitch” |
| TV Picture Settings | “TV Picture settings” |
| | “Picture settings” |
| Brightness settings | “Change TV brightness” |
| | “decrease TV brightness” |
| | “make the screen brighter” |
| | “adjust brightness settings” |
| <HDMI> Picture settings | “HDMI Brightness” |
| | “Make Xbox brighter” |
| TV input settings | “TV input settings” |
| Setup HDMI | “Set up HDMI” |
| | “input setup” |
| <Specific Input> Setting | “HDMI 1 settings” |
| | “Xbox settings” |
| Rename input | “Rename HDMI 1” |
| | “change HDMI1 to PlayStation” |
| Remove input | “Remove HDMI 1” |
| Audio | “Audio settings” |
| | “Sound settings” |
| Audio output | “Change audio output to speakers” |
| | “check audio output” |
| Menu volume | “Increase menu volume” |
| | “turn off menu sound effects” |
| Audio language preference | “Change audio to Spanish” |
| | “Set audio to German” |
| | “Change default audio to French” |
| Audio streaming format preference | “Change to Dolby sound” |
| Digital output format | “Change digital output format” |
| Dolby Digital Audio | “Change audio to Dolby Digital” |
| Dolby Digital Plus | “Change audio to Dolby Digital Plus” |
| DTS Audio | “Change audio to DTS” |
| Stereo Audio | “Change audio to Stereo” |
| Access Parental Controls | “Parental controls” |
| | “go to parental controls” |
| Block all unrated programs | “Block unrated programs” |
| Change PIN | “Change Parental controls PIN” |
| Reset Parental controls | “Reset Parental controls settings” |
| | “turn off parental controls” |
| | “remove parental controls” |
| | “unblock content” |
| Enter guest mode | “Start Guest Mode” |
| | “enter Guest Mode” |
| Guest mode | “Guest Mode” |
| | “go to Guest Mode settings” |
| Sign out guest mode | “Sign out of Guest Mode” |
| | “Log out of Guest Mode” |
| Exit guest mode | “Exit Guest Mode” |
| | “Stop Guest Mode” |
| Home screen Layout and menu | “Home screen settings” |
| | “Home layout” |
| Recommendation Rows | “Recommendation Rows” |
| | “Remove Browse row” |
| | “Hide Categories row” |
| <MENU ITEMS> | “Customize home screen menu” |
| | “Remove Live TV from Home Screen” |
| | “Remove Featured Free” |
| Shortcuts | “Hide sleep timer shortcut” |
| | “Customize shortcuts” |
| | “Remove ‘add channels’ shortcut” |
| | “add shortcut” |
| Add/Update payment method | “Credit card on file” |
| | “update method of payment” |
| | “What credit card do I have saved?” |
| | “View my credit card” |
| Apple AirPlay and HomeKit | “Airplay settings” |
| | “Apple HomeKit” |
| Legal Notices | “Legal notices” |
| Account Terms and Conditions | “Account Terms and Conditions” |
| Terms of Use | “Terms of Use” |
| Third-party licenses | “Third-party licenses” |
| Regulatory e- label | “Regulatory e-label” |
| Privacy OR | “Privacy settings” |
| Privacy Policy | “Go to Privacy” |
| | “Privacy policy” |
| Advertising | “Advertising settings” |
| | “Ad privacy” |
| Sensitive ad content | “Sensitive ad content” |
| | “customize ads” |
| | “change ad profile” |
| Reset advertising | “Reset advertising” |
| Personalize ads | “Personalize ads” |
| | “ad personalization” |
| Voice Privacy | “Voice permissions” |
| | “Voice Privacy” |
| Microphone access | “Microphone access privacy settings” |
| | “microphone privacy” |
| Speech recognition | “Speech recognition privacy settings” |
| | “voice data privacy” |
| Help | “Help” |
| | “Help with my Roku” |
| | “How to use Roku” |
| System Settings OR | “System settings” |
| Advanced system settings | “Advanced system settings” |
| System Info | “System information” |
| | “about my Roku” |
| Account email | “Roku account email” |
| | “What is my Roku account?” |
| | “What is the Roku user on this?” |
| TV model number | “My TV model” |
| | “What kind of TV do I have?” |
| | “What kind of Roku is this?” |
| Serial Number | “Serial number” |
| | “What is my Roku serial number? |
| Software version | “What's my software version” |
| | “What software am I running?” |
| Device ID | “Device ID” |
| | “What is my Device's ID?” |
| ZIP Code | “Change zip code” |
| | “What is my ZIP code?” |
| Time settings | “Time settings” |
| Time zones | “Change time zone” |
| | “Change to Pacific time” |
| | “Set time zone to EST” |
| Clock format | “Change clock format” |
| 12 hour | “Change clock format to 12 hour” |
| 24 hour | “Change clock format to 24 hour” |
| | “Change to 24 hour clock” |
| Clock UI - show/hide | “Hide clock” |
| | “Show clock in top right” |
| | “Unhide clock” |
| Power | “Power settings” |
| Power on settings | “Power on settings” |
| | “Customize power on state” |
| | “Choose input for automatic start-up” |
| Auto-power savings | “Turn on power savings” |
| | “Power save mode” |
| Standby LED | “Turn off TV LED” |
| | “Standby light” |
| Fast TV Start | “Fast TV Start” |
| | “Let Xbox automatically switch input” |
| | “Allow casting while TV is off” |
| | “Enable power on voice command” |
| System restart | “Restart my TV” |
| USB media | “USB settings” |
| Control other devices (CEC) | “CEC settings” |
| | “Go to CEC” |
| | “What is CEC?” |
| | “Control other devices |
| Language | “Change system language” |
| | “Change language to Spanish” |
| | “Change system to French” |
| | “Change my Roku language to German” |
| Screen mirroring | “Screen mirroring” |
| | “Cast from my phone” |
| | “Project from my laptop” |
| | “Screen casting” |
| Software update | “Software update” |
| | “Check for updates” |
| Factory reset | “Factory reset” |

In some embodiments, the mapping of device task intents with corresponding representative utterances can be used by model training 550 as training data set 560 for training and/or finetune machine learning model 520. Training machine learning model 520 can include updating parameters of machine learning model 520 through forward propagation, loss calculation, backpropagation, and parameter updates using Gradient Descent. Exemplary techniques for fine-tuning machine learning model 520 can include transfer learning, low-rank adaptation, use of adapters or small neural networks inserted into machine learning model 520, prefix tuning, prompt tuning, hyperparameter optimization, knowledge distillation, data augmentation, etc.

To make machine learning model 520 more robust, large language model 580 can be prompted and used to generate alternative utterances based on the representative utterances and/or device task intents. An example of a prompt can include, “You are a user of an entertainment system. You would like to [INSERT DEVICE TASK INTENT] on the entertainment system. Generate 100 examples of voice commands that you would say. Vary them slightly and greatly. Representative examples can include [INSERT REPRESENTATIVE UTERRANCE(S)]” The generated alternative utterances corresponding to various device task intents can be added to training data set 560 and used by model training 550 to train and/or finetune machine learning model 520.

In one example, large language model 580 may receive the following prompt:

You are a user of an entertainment system. You would like to change
your network settings on the entertainment system. Generate 5
examples of voice commands that you would say. Vary them slightly
and greatly. Representative examples include: change my wifi”

Large language model 580 may output the following response:

```
Sure! Here are five varied examples of voice commands you might use to
change your network settings on an entertainment system:
  1. “Change my Wi-Fi settings.”
  2. “Update the network connection.”
  3. “Switch to a different Wi-Fi network.”
  4. “Modify my internet settings.”
  5. “Connect to a new wireless network.”
```

The examples produced by large language model 580, along with the device task intent of “network settings” can be added to 560//.

Herein, a large language model can be a type of artificial intelligence system that uses deep learning techniques, specifically transformers and self-attention mechanisms, to process and generate human-like text based on patterns learned from vast amounts of training data. A large language model can include a transformer-based architecture. The transformer is one of the building blocks of a large language model. The transformer is a type of neural network that uses self-attention mechanisms to capture long-range dependencies in sequential data, such as text. The transformer architecture includes an encoder and a decoder, both having multiple (multi-head) attention layers and feed-forward neural network layers. A large language model may include embeddings layer, an encoder, a decoder, and output layer. Embeddings layer converts the input text into numerical vector representations called embeddings. These embeddings represent the semantic and syntactic properties of words, allowing the large language model to understand the meaning and context of the input. Since the transformer architecture does not have an inherent notion of word order, positional encodings can be added to the input embeddings to provide the model with information about the position of each word in the sequence. The encoder processes the input sequence and creates a context-aware representation. The encoder includes multiple attention layers and feed-forward neural network layers. The decoder takes the encoded input representation from the encoder and generates the output sequence, token by token. The decoder can autoregressively generate output tokens one by one, attending to the encoded input and the previous output. The decoder includes multiple attention layers and feed-forward neural network layers. The output layer takes the representations from the decoder and can output probability distributions over the vocabulary for the next token in the sequence. The attention layers allow the model to weigh different parts of the input sequence when producing the output. The attention mechanism enables the model to focus on the most relevant parts of the input for a given task, such as generating a coherent and contextually appropriate response. Multi-head attention is a technique that allows the large language model to attend to different representations of the input simultaneously. Multi-head attention may include several attention heads, each of which learns to attend to different aspects of the input, improving the model's ability to capture complex relationships and patterns. Feed-forward neural network layers apply non-linear transformations to the output of the attention layers, allowing the model to learn more complex representations of the input data.

Advantageously, the representative utterances do not need to capture all possible variations of utterances for a given device task intent. Large language model 580 can leverage its understanding of language generate and expand training data set 560 to help machine learning model 520 learn to detect device task intents even when the uttered text 490 includes a natural variation of a representative utterance or a semantically similar version of a representative utterance.

In some embodiments, model output 480 may indicate that there is high confidence that uttered text 490 is for a (single) detected device task intent. Model output 480 may indicate that the confidence level associated with the detected device task intent exceeds or is greater than a high confidence threshold (e.g., 90% confidence level).

In some embodiments, model output 480 may indicate that the uttered text 490 is likely for a first detected device task intent or a second detected device task intent. Model output 480 may indicate that a first confidence level associated with the first detected device task intent and a second confidence level associated with the second detected device task intent are greater than a moderate confidence threshold (35% confidence level).

In some embodiments, model output 480 may indicate that the uttered text 490 is unlikely to have any device task intent.

In some embodiments, model output 480 may indicate the uttered text 490 likely corresponds to one or more detected device task intents (e.g., 1, 2, or 3 detected device task intents) ranked in the order of the confidence level from high to low.

### Exemplary Voice for Device Tasks Application and Methods Implemented by Voice for Device Tasks Application

FIG. 6 illustrates voice for device tasks application 240, according to some embodiments of the disclosure. Voice for device tasks application 240 can include handling logic 606, which receives model output 480. Handling logic 606 may change a graphical user interface of the user device according to the output of the device task intent understanding model.

Handling logic 606 may include send user to deep link 660. Send user to deep link 660 may update a graphical user interface based on model output 480. Send user to deep link 660 may update a graphical user interface to display a destination page (e.g., a device task page in a settings tree or task tree, with optional focus) that corresponds to a detected device task intent in model output 480. Handling logic 606, such as send user to deep link 660 may include or have access to deep links 604, to determine the corresponding destination page. Send user to deep link 660 may determine the destination page corresponding to a detected device task intent using deep links 604.

As discussed previously, a device task intent has a mapping to, or has a deep link to, a destination page where a user can then perform the intended device task. The various mappings are stored in deep links 604. Conventions for describing a destination page or a page for a deep link is as follows:

| Deep Link Path | Meaning |
|---|---|
| > | Click through |
| Settings>System | Focus on System |
| Settings>System>About | Click System and focus is on About |
| Settings>System>About> | Click System, Click About (goes to |
| | the default focus) |
| Settings>System>Time> | Click System, Click Time (goes to |
| | the default focus) |

The following table illustrates an exemplary set of deep links 604 that map different device task intents and destination pages that correspond to the device task intents:

| Device Task Intent | Deep Link Path to Destination Page |
|---|---|
| Settings | Settings> |
| Network settings | Settings>Network>About |
| Network name | Settings>Network>About |
| Status | Settings>Network>About |
| Signal Strength | Settings>Network>About |
| IP address | Settings>Network>About |
| Wireless MAC address | Settings>Network>About |
| Check connection | Settings>Network>Check connection |
| Connect to Internet | Settings>Network>Set up connection |
| Remotes & devices | Settings>Remotes & devices>Remotes |
| Hands-free voice | Settings>Remotes & devices>Remotes> |
| Add new remote | Settings>Remotes & devices>Remotes>Add a new remote |
| Speakers | Settings>Remotes & devices>Speakers> OR |
| | Settings>Remotes & devices |
| Add new speaker | Settings>Remotes & devices>Speakers> OR |
| | Settings>Remotes & devices |
| Soundbar | Settings>Remotes & devices>Speakers> OR |
| | Settings>Remotes & devices |
| Soundbar About | Settings>Remotes & devices>Speakers> OR |
| | Settings>Remotes & devices |
| Soundbar Restart | Settings>Remotes & devices>Speakers> OR |
| | Settings>Remotes & devices |
| Soundbar Factory reset | Settings>Remotes & devices>Speakers> OR |
| | Settings>Remotes & devices |
| <Rear left> speaker | Settings>Remotes & devices>Speakers> OR |
| | Settings>Remotes & devices |
| <Rear left> speaker About | Settings>Remotes & devices>Speakers> OR |
| | Settings>Remotes & devices |
| <Rear left> speaker Restart | Settings>Remotes & devices>Speakers> OR |
| | Settings>Remotes & devices |
| <Rear left> speaker Factory Reset | Settings>Remotes & devices>Speakers> OR |
| | Settings>Remotes & devices |
| Subwoofer | Settings>Remotes & devices>Speakers> OR |
| | Settings>Remotes & devices |
| Subwoofer About | Settings>Remotes & devices>Speakers> OR |
| | Settings>Remotes & devices |
| Subwoofer Restart | Settings>Remotes & devices>Speakers> OR |
| | Settings>Remotes & devices |
| Subwoofer Factory Reset | Settings>Remotes & devices>Speakers> OR |
| | Settings>Remotes & devices |
| Wireless headphones | Settings>Remotes & devices>Wireless Headphones |
| Add new wireless headphones | Settings>Remotes & devices>Wireless Headphones |
| Smartphones and tablets | Settings>Remotes & devices>Wireless Headphones |
| Add new smartphone or tablet | Settings>Remotes & devices>Wireless Headphones |
| Add device | Settings>Remotes & devices>Add devices |
| Wallpapers & Screensavers OR | Settings>Theme> OR |
| Theme | Settings>Wallpapers & Screensavers> |
| Theme packs | Settings>Theme> OR |
| | Settings>Wallpapers & Screensavers> |
| Wallpapers | Settings>Theme> OR |
| | Settings>Wallpapers & Screensavers> |
| Screensaver | Settings>Theme> OR |
| | Settings>Wallpapers & Screensavers> |
| Sounds | Settings>Theme> OR |
| | Settings>Wallpapers & Screensavers> |
| Screensaver start time | Settings>Theme> OR |
| | Settings>Wallpapers & Screensavers> |
| Default theme | Settings>Theme> OR |
| | Settings>Wallpapers & Screensavers> |
| Display Type | Settings>Display type> OR |
| | Do not navigate to settings. |
| Accessibility Settings | Settings>Accessibility>Captions mode |
| Select captions language | Settings>Accessibility>Captions mode |
| Change captions style | Settings>Accessibility>Captions mode |
| Screen reader | Settings>Accessibility>Screen reader |
| Speech rate | Settings>Accessibility>Screen reader |
| Screen reader volume | Settings>Accessibility>Screen reader |
| Screen reader pitch | Settings>Accessibility>Screen reader |
| TV Picture Settings | Settings>TV picture settings OR |
| | Do not navigate to settings. |
| Brightness settings | Settings>TV picture settings OR |
| | Do not navigate to settings. |
| <HDMI> Picture settings | Settings>TV picture settings OR |
| | Do not navigate to settings. |
| TV input settings | Settings>TV inputs OR |
| | Do not navigate to settings. |
| Setup HDMI | Settings>TV inputs OR |
| | Do not navigate to settings. |
| <Specific Input> Setting | Settings>TV inputs OR |
| | Do not navigate to settings. |
| Rename input | Settings>TV inputs OR |
| | Do not navigate to settings. |
| Remove input | Settings>TV inputs OR |
| | Do not navigate to settings. |
| Audio | Settings>Audio>Audio output OR |
| | Settings>Audio>Menu volume |
| Audio output | Settings>Audio>Audio output OR |
| | Settings>Audio>Menu volume |
| Menu volume | Settings>Audio>Audio output OR |
| | Settings>Audio>Menu volume |
| Audio language preference | Settings>Audio>Audio output OR |
| | Settings>Audio>Menu volume |
| Audio streaming format preference | Settings>Audio>Audio output OR |
| | Settings>Audio>Menu volume |
| Digital output format | Settings>Audio>Audio output OR |
| | Settings>Audio>Menu volume |
| Dolby Digital Audio | Settings>Audio>Audio output OR |
| | Settings>Audio>Menu volume |
| Dolby Digital Plus | Settings>Audio>Audio output OR |
| | Settings>Audio>Menu volume |
| DTS Audio | Settings>Audio>Audio output OR |
| | Settings>Audio>Menu volume |
| Stereo Audio | Settings>Audio>Audio output OR |
| | Settings>Audio>Menu volume |
| Access Parental Controls | Settings>Parental controls> OR |
| | Do not navigate to settings. |
| Block all unrated programs | Settings>Parental controls> OR |
| | Do not navigate to settings. |
| Change PIN | Settings>Parental controls> OR |
| | Do not navigate to settings. |
| Reset Parental controls | Settings>Parental controls> OR |
| | Do not navigate to settings. |
| Enter guest mode | Settings>Guest Mode>Enter Guest Mode> |
| Guest mode | Settings>Guest Mode>Enter Guest Mode> |
| Sign out guest mode | Settings>Guest Mode>Enter Guest Mode> |
| Exit guest mode | Settings>Guest Mode>Enter Guest Mode> |
| Home screen Layout and menu | Settings>Home screen |
| Recommendation Rows | Settings>Home screen |
| <MENU ITEMS> | Settings>Home screen |
| Shortcuts | Settings>Home screen>Shortcuts |
| Add/Update payment method | Settings>Payment method>Add payment method OR |
| | Settings>Payment method>Update payment method OR |
| | Settings>Payment method>Update payment method> |
| Apple AirPlay and HomeKit | Settings>Apple AirPlay and HomeKit |
| Legal Notices | Settings>Legal notices>Privacy policy |
| Account Terms and Conditions | Settings>Legal notices>Privacy policy |
| Terms of Use | Settings>Legal notices>Privacy policy |
| Third-party licenses | Settings>Legal notices>Privacy policy |
| Regulatory e- label | Settings>Legal notices>Privacy policy |
| Privacy OR | Settings>Privacy>Advertising |
| Privacy Policy | |
| Advertising | Settings>Privacy>Advertising |
| Sensitive ad content | Settings>Privacy>Advertising |
| Reset advertising | Settings>Privacy>Advertising |
| Personalize ads | Settings>Privacy>Advertising |
| Voice Privacy | Settings>Privacy>Voice |
| Microphone access | Settings>Privacy>Voice |
| Speech recognition | Settings>Privacy>Voice |
| Help | Settings>Help>Voice Help |
| System Settings OR | Settings>System>About |
| Advanced system settings | |
| System Info | Settings>System>About> |
| Account email | Settings>System>About> |
| TV model number | Settings>System>About> |
| Serial Number | Settings>System>About> |
| Software version | Settings>System>About> |
| Device ID | Settings>System>About> |
| ZIP Code | Settings>System>ZIP Code> |
| Time settings | Settings>System>Time> |
| Time zones | Settings>System>Time> |
| Clock format | Settings>System>Time> |
| 12 hour | Settings>System>Time> |
| 24 hour | Settings>System>Time> |
| Clock UI - show/hide | Settings>System>Time> |
| Power | Settings>System>Power> OR |
| | Settings>System>Power> |
| Power on settings | Settings>System>Power> OR |
| | Settings>System>Power> |
| Auto-power savings | Settings>System>Power> OR |
| | Settings>System>Power> |
| Standby LED | Settings>System>Power> OR |
| | Settings>System>Power> |
| Fast TV Start | Settings>System>Power>Fast TV Start OR |
| | Do not navigate to settings |
| System restart | Settings>System>Power>System restart |
| USB media | Settings>System>USB media>Auto-launch |
| Control other devices (CEC) | Settings>System>Control other devices (CEC)> |
| Language | Settings>System>Language> |
| Screen mirroring | Settings>System>Screen mirroring>Screen mirroring mode |
| Software update | Settings>System>Software update> |
| Factory reset | Settings>System>Advanced system settings>Factory reset |

In some embodiments, send user to deep link 660 may include displaying a message (e.g., in a heads-up display) in a region on the destination page once the user has been sent to the destination page. The message may indicate to the user that a detected device task intent can be performed or found on the device task page. The following table illustrates an exemplary set of messages 608 corresponding to different device task intents:

| Device Task Intent | Message (For Heads-Up Display) |
|---|---|
| Settings | Here are your settings |
| Network settings | Here are your network settings |
| Network name | Here are your network details |
| Status | Here are your network details |
| Signal Strength | Here are your network details |
| IP address | Here are your network details |
| Wireless MAC address | Here are your network details |
| Check connection | Here's the setting to check your network connection |
| Connect to Internet | Here's the setting to set up a connection |
| Remotes & devices | Here are the settings for remotes & devices |
| Hands-free voice | Here are your remote settings |
| Add new remote | Here's the setting to add a new remote |
| Speakers | Here are the speaker settings OR |
| | Here are the settings for audio output devices |
| Add new speaker | Here are the speaker settings OR |
| | Here are the settings for audio output devices |
| Soundbar | Here are the speaker settings OR |
| | Here are the settings for audio output devices |
| Soundbar About | Here are the speaker settings OR |
| | Here are the settings for audio output devices |
| Soundbar Restart | Here are the speaker settings OR |
| | Here are the settings for audio output devices |
| Soundbar Factory reset | Here are the speaker settings OR |
| | Here are the settings for audio output devices |
| <Rear left> speaker | Here are the speaker settings OR |
| | Here are the settings for audio output devices |
| <Rear left> speaker About | Here are the speaker settings OR |
| | Here are the settings for audio output devices |
| <Rear left> speaker Restart | Here are the speaker settings OR |
| | Here are the settings for audio output devices |
| <Rear left> speaker Factory Reset | Here are the speaker settings OR |
| | Here are the settings for audio output devices |
| Subwoofer | Here are the speaker settings OR |
| | Here are the settings for audio output devices |
| Subwoofer About | Here are the speaker settings OR |
| | Here are the settings for audio output devices |
| Subwoofer Restart | Here are the speaker settings OR |
| | Here are the settings for audio output devices |
| Subwoofer Factory Reset | Here are the speaker settings OR |
| | Here are the settings for audio output devices |
| Wireless headphones | Here are the settings for audio output devices |
| Add new wireless headphones | Here are the settings for audio output devices |
| Smartphones and tablets | Here are the settings for audio output devices |
| Add new smartphone or tablet | Here are the settings for audio output devices |
| Add device | Here's the setting to add devices |
| Wallpapers & Screensavers OR | Here are the settings for wallpapers & screensavers |
| Theme | |
| Theme packs | Here are the settings for wallpapers & screensavers |
| Wallpapers | Here are the settings for wallpapers & screensavers |
| Screensaver | Here are the settings for wallpapers & screensavers |
| Sounds | Here are the settings for wallpapers & screensavers |
| Screensaver start time | Here are the settings for wallpapers & screensavers |
| Default theme | Here are the settings for wallpapers & screensavers |
| Display Type | Here are settings for display type OR |
| | Error = “Display type settings are not available on this device” |
| Accessibility Settings | Here are the accessibility settings |
| Select captions language | Here are the settings for captions |
| Change captions style | Here are the settings for captions |
| Screen reader | Here are the settings for screen reader |
| Speech rate | Here are the settings for screen reader |
| Screen reader volume | Here are the settings for screen reader |
| Screen reader pitch | Here are the settings for screen reader |
| TV Picture Settings | Here are the TV picture settings OR |
| | Error = “Picture settings are not available on this device” |
| Brightness settings | Here are the TV picture settings OR |
| | Error = “Picture settings are not available on this device” |
| <HDMI> Picture settings | Here are the TV picture settings OR |
| | Error = “Picture settings are not available on this device” |
| TV input settings | Here are the settings for TV inputs OR |
| | Error = “TV inputs settings are not available on this device” |
| Setup HDMI | Here are the settings for TV inputs OR |
| | Error = “TV inputs settings are not available on this device” |
| <Specific Input> Setting | Here are the settings for TV inputs OR |
| | Error = “TV inputs settings are not available on this device” |
| Rename input | Here are the settings for TV inputs OR |
| | Error = “TV inputs settings are not available on this device” |
| Remove input | Here are the settings for TV inputs OR |
| | Error = “TV inputs settings are not available on this device” |
| Audio | Here are the audio settings |
| Audio output | Here are the audio settings |
| Menu volume | Here are the audio settings |
| Audio language preference | Here are the audio settings |
| Audio streaming format preference | Here are the audio settings |
| Digital output format | Here are the audio settings |
| Dolby Digital Audio | Here are the audio settings |
| Dolby Digital Plus | Here are the audio settings |
| DTS Audio | Here are the audio settings |
| Stereo Audio | Here are the audio settings |
| Access Parental Controls | Here are the settings for parental controls OR |
| | Error = “Parental controls settings are not available on this |
| | device” |
| Block all unrated programs | Here are the settings for parental controls OR |
| | Error = “Parental controls settings are not available on this |
| | device” |
| Change PIN | Here are the settings for parental controls OR |
| | Error = “Parental controls settings are not available on this |
| | device” |
| Reset Parental controls | Here are the settings for parental controls OR |
| | Error = “Parental controls settings are not available on this |
| | device” |
| Enter guest mode | Here are the Guest Mode settings |
| Guest mode | Here are the Guest Mode settings |
| Sign out guest mode | Here are the Guest Mode settings |
| Exit guest mode | Here are the Guest Mode settings |
| Home screen Layout and menu | Here are the settings for the home screen |
| Recommendation Rows | Here are the settings for the home screen |
| <MENU ITEMS> | Here are the settings for the home screen |
| Shortcuts | Here are the settings for shortcuts |
| Add/Update payment method | Here are the settings for payment method |
| Apple AirPlay and HomeKit | Here are the settings for Apple AirPlay and HomeKit |
| Legal Notices | Here are the legal notices |
| Account Terms and Conditions | Here are the legal notices |
| Terms of Use | Here are the legal notices |
| Third-party licenses | Here are the legal notices |
| Regulatory e- label | Here are the legal notices |
| Privacy OR | Here are your privacy settings |
| Privacy Policy | |
| Advertising | Here are your privacy settings |
| Sensitive ad content | Here are your privacy settings |
| Reset advertising | Here are your privacy settings |
| Personalize ads | Here are your privacy settings |
| Voice Privacy | Here are your settings for voice privacy |
| Microphone access | Here are your settings for voice privacy |
| Speech recognition | Here are your settings for voice privacy |
| Help | Here are the settings for help |
| System Settings OR | Here are the system settings |
| Advanced system settings | |
| System Info | Here's the system information |
| Account email | Here's the system information |
| TV model number | Here's the system information |
| Serial Number | Here's the system information |
| Software version | Here's the system information |
| Device ID | Here's the system information |
| ZIP Code | Here's your ZIP code setting |
| Time settings | Here are the time settings |
| Time zones | Here are the time settings |
| Clock format | Here are the time settings |
| 12 hour | Here are the time settings |
| 24 hour | Here are the time settings |
| Clock UI - show/hide | Here are the time settings |
| Power | Here are the power settings |
| Power on settings | Here are the power settings |
| Auto-power savings | Here are the power settings |
| Standby LED | Here are the power settings |
| Fast TV Start | Here are the settings for Fast TV Start OR |
| | Error = “Fast TV Start setting is not available on this device” |
| System restart | Here's the setting for system restart |
| USB media | Here are the settings for USB media |
| Control other devices (CEC) | Here are the settings to control other devices (CEC) |
| Language | Here is the language setting |
| Screen mirroring | Here are the settings for screen mirroring |
| Software update | Here's the setting for software update |
| Factory reset | Here are the settings for factory reset |

Handling logic 606 may include display choices to user 662. Display choices to user 662 may update a graphical user interface based on model output 480, e.g., when model output 480 indicates there are multiple detected device task intents, or that the device task intent model is not sure. Display choices to user 662 may update a graphical user interface to display multiple selectable links corresponding to different detected device task intents in model output 480. The selectable link, if selected by user, may send the user to a particular destination page. A selectable link is a hyperlink to a destination page. Display choices to user 662 may include or have access to deep links 604, to determine the different destination pages corresponding to the different detected device task intents and generate the selectable links for the destination pages. Display choices to user 662 may update the graphical user interface to display a first selectable link to the first device task page and a second selectable link to the second device task page.

In one example, a user makes an utterance, “change language”. The utterance may correspond to different (overlapping) device task intents, such as “system language” “audio language” “captions preferred language”. Model output 480 may indicate that the utterance may correspond to multiple device task intents. “System language” may have a high probability or likelihood to correspond to the intended device task intent. “Audio language” may have a high probability or likelihood to correspond to the intended device task intent. “Audio language” may have a low probability or likelihood to correspond to the intended device task intent. Instead of changing the graphical user interface to display a destination page according to the device task intent with the highest probability or likelihood, display choices to user 662 may update a graphical user interface to display a first selectable link with the text “system language” that would link the user to a destination page corresponding to “system language” in deep links 604 if the user selects the first selectable link, a second selectable link with the text “audio language” that would link the user to a destination page corresponding to “audio language” in deep links 604 if the user selects the second selectable link, and a third selectable link with the text “captions language” that would link the user to a destination page corresponding to “captions language” in deep links 604 if the user selects the third selectable link. Display choices to user 662 may also update the graphical user interface to show a disambiguation heads-up display having a message, “which setting do you mean?” along with the selectable links. Display choices to user 662 prevents voice for device tasks application 240 from executing erroneously to take a user to a destination page that does not match the intended device task intent.

Handling logic 606 may include context dependent and device task type dependent handling 664. Context dependent and device task type dependent handling 664 can handle a variety of special scenarios where the graphical user interface may respond differently to a given detected device task intent in model output 480 to prevent jarring or undesirable user interface behavior. Phrased differently, context dependent and device task type dependent handling 664 may change the graphical user interface based on a context and/or a type of the device task intent. By taking context and/or device task type into account, the graphical user interface is updated or changed to make the user experience as natural as possible. Examples of contexts may include: a native media player running on the user device is in playback mode, a third-party media application running on the user device is in use but is not in playback mode, a third-party media application running on the user device is in use and is in playback mode, a native user application running on the user device is in use but is not in playback mode, and an electronic program guide running on the user device is in use. Examples of types of device task intents may include: the type being one of: unique to the third-party media application in playback mode, found in both an operating system task tree and an overlay task tree, unique to the operating system task tree, and unique to the overlay task tree.

Handling logic 606 may include device task unsupported messaging 666. Device task unsupported messaging 666 can change the graphical user interface to output error messaging if one or more detected device task intents in model output 480 is unsupported by a device. The error message may differ depending on the number of detected device task intents that are unsupported by the user device. In some cases, a device task intent may only be supported by a smart television system (e.g., smart television system 202 of FIG. 2). One example is “brightness settings”. In some cases, a device task intent may only be supported by a media player system connected to a TV (e.g., media player system 302 of FIG. 3). One example is “wireless headphones”. In some cases, a device task intent is supported by both a smart television system and a media player system connected to a TV. One example is “select captions language”.

User event driven voice hinting 810 modifies the graphical user interface to provide hints to users so the users can learn to use voice for performing device tasks. Voice hints for device tasks may be output to assist the end user. For example, voice hint text or message may be displayed as a countdown mini-heads-up display when a specific trigger occurs. Moreover, the voice hint text can be specific to the specific trigger. Ensuring that a relevant voice hint text is displayed only when a special trigger occurs ensures that the voice hinting text is displayed when it is most relevant to the user and the present user interactions and ensures that the voice hint is most effective. Special triggers include tracking and determining whether user interactions match or follow a sequence of user interactions using a remote to navigate through the settings menu to reach a specific device task page. Once the user interactions are detected to match a specific special trigger, a relevant voice hint text is determined and displayed. An exemplary specific trigger includes a user selecting “Settings” in a main menu using a remote and navigating through a settings menu using the remote to a task page for changing wallpaper. Exemplary voice hint text are illustrated below. Text can be chosen randomly from the applicable row:

| | Hint Text (For Mini-Heads-Up Display) |
|---|---|
| Push-to-talk | 1. Use voice for settings! \nFor example, “Change my wallpaper” |
| (PTT) with | 2. Use voice for settings! \nFor example, “Check for software updates” |
| history | 3. Use voice for settings! \nFor example, “Add a new remote” |
| | 4. Use voice for settings! \nFor example, “Accessibility features” |
| | 5. Use voice for settings! \nFor example, “Turn on parental controls” |
| | 6. Use voice for settings! \nFor example, “Customize home screen” |
| PTT without | 1. Use voice! Press & hold <MIC> to speak. \nFor example, “Change my wallpaper” |
| history | 2. Use voice! Press & hold <MIC> to speak. \nFor example, “Check for software |
| | updates” |
| | 3. Use voice! Press & hold <MIC> to speak. \nFor example, “Add a new remote” |
| | 4. Use voice! Press & hold <MIC> to speak. \nFor example, “Accessibility features” |
| | 5. Use voice! Press & hold <MIC> to speak. \nFor example, “Turn on parental |
| | controls” |
| | 6. Use voice! Press & hold <MIC> to speak. \nFor example, “Customize home |
| | screen” |
| Hands-Free | 1. Use hands-free voice! For example, say, \n“Hey Roku, change my wallpaper” |
| (HF) | 2. Use hands-free voice! For example, say, \n“Hey Roku, check for software |
| | updates” |
| | 3. Use hands-free voice! For example, say, \n“Hey Roku, add a new remote” |
| | 4. Use hands-free voice! For example, say, \n“Hey Roku, accessibility features” |
| | 5. Use hands-free voice! For example, say, \n“Hey Roku, turn on parental controls” |
| | 6. Use hands-free voice! For example, say, \n“Hey Roku, customize home screen” |

User event driven voice hinting 810 may implement a hint suppression algorithm to not display a voice hint even when the special trigger occurs. Hint suppression ensures that hints are not overused (e.g., avoid overexposure) and decreases the chances that a user would ignore them. In some embodiments, the hint suppression algorithm includes not showing any voice hints if a device setup occurred a number of days ago (e.g., 2 days ago). In some embodiments, the hint suppression algorithm includes not showing a specific voice hint if the voice command or a similar voice command for perform the device task was used T times in the last D number of days (e.g., T=1, D=45). In some embodiments, the hint suppression algorithm includes not showing a specific voice hint if the specific voice hint appeared H hours ago (e.g., H=48). In some embodiments, the hint suppression algorithm includes not showing a specific voice hint if the specific voice hint has already appeared A times on the user device (e.g., A=5, A=100).

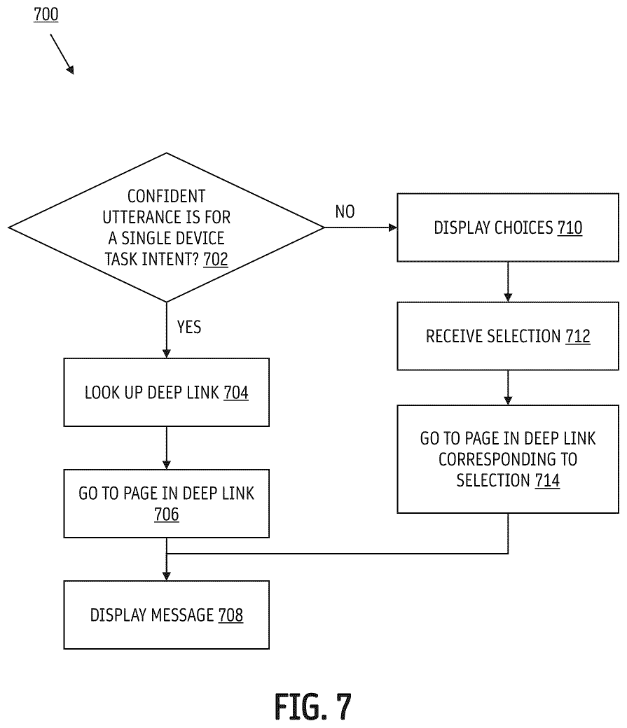

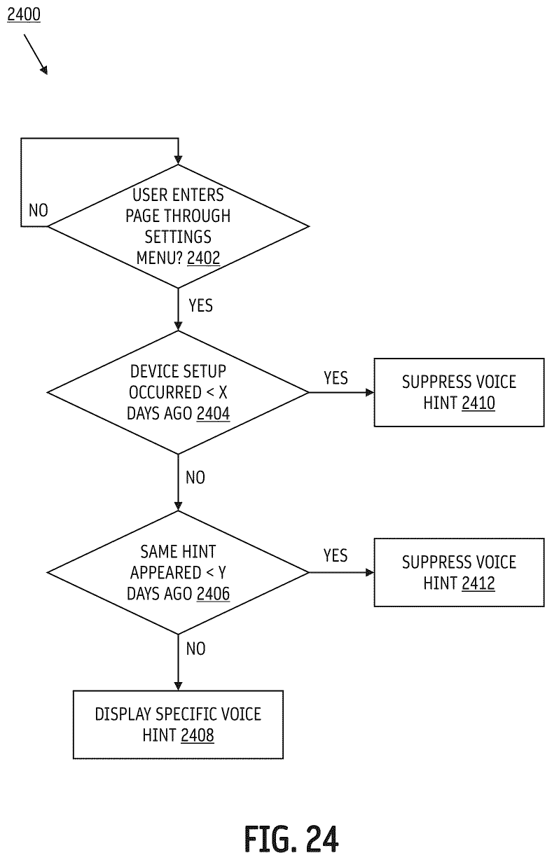

Exemplary methods implemented by handling logic 606 are illustrated in FIGS. 7, 11, 13, 17, 19, and 21. Exemplary method implemented by user event driven voice hinting 810 is illustrated in FIG. 24.

FIG. 7 depicts a flow diagram illustrating method 700 for changing the graphical user interface based on an output of the device task intent understanding model, according to some embodiments of the disclosure. Method 700 may be implemented by handling logic 606 of voice for device tasks application 240 of FIG. 6 (e.g., send user to deep link 660 and/or display choices to user 662).

In 702, an output of the device task intent understanding model is analyzed to determine whether the device task intent understanding model is confident that a user utterance is for a single device task intent, or not.

For example, 702 may include determining, based on the output of the device task intent understanding model, that the user utterance corresponds to a first detected device task intent. 702 may include determining, based on the output of the device task intent understanding model, that a first detected device task intent has a confidence level that exceeds a high confidence threshold (and other intents do not have confidence levels that exceed that high confidence threshold). The determination takes method 700 via the “YES” path to 704.

In 704, a deep link is looked up. For example, deep links are reviewed to determine the destination page that corresponds to the first detected device task intent. For example, 704 may include determining a first device task page that corresponds to the first detected device task intent based on a set of deep links that maps different device task intents to different device task pages.

In 706, the graphical user interface changes to go to the destination page of the deep link. For example, 706 may include updating the graphical user interface to display the first device task page.

In 708, a message is displayed in a countdown heads-up display to inform the user that the user can perform a device task. For example, 708 may include displaying a message in a region of the first device task page, the message indicating that a first detected device task intent can be performed or found on the first device task page.

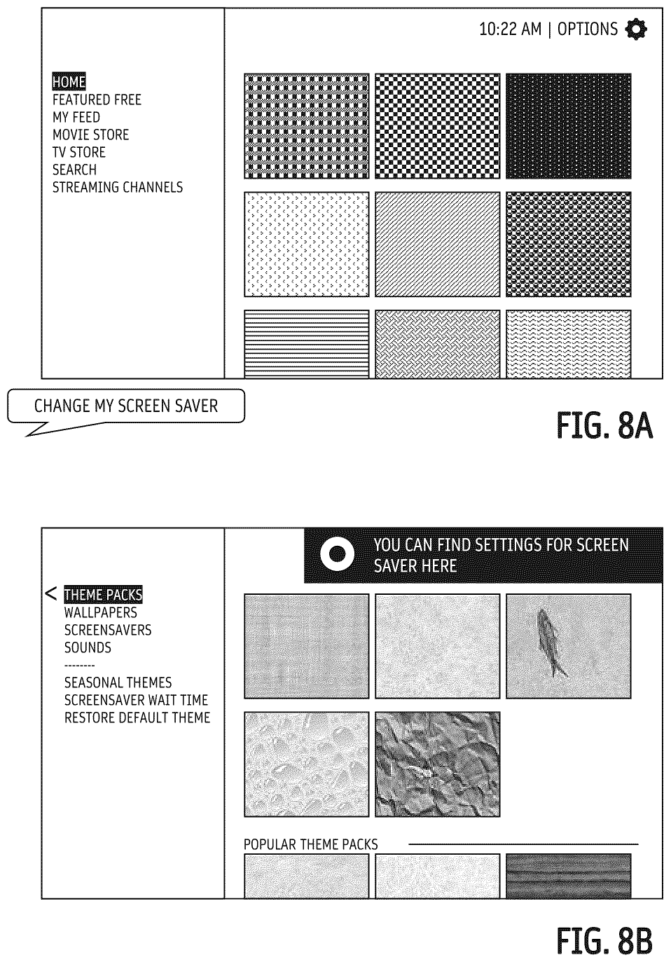

FIG. 8A depicts a graphical user interface when a user makes an utterance, according to some embodiments of the disclosure. For example, a user may make an utterance “change my screen saver”. FIG. 8B depicts a graphical user interface displaying a device task page that corresponds to a detected device task intent of the utterance illustrated in FIG. 8A, according to some embodiments of the disclosure. Following method 700, the graphical user interface is updated as depicted in FIG. 8B to display a device task page for changing theme packs and a message “you can find settings for screen saver here” is displayed in a countdown (mini) heads-up display.

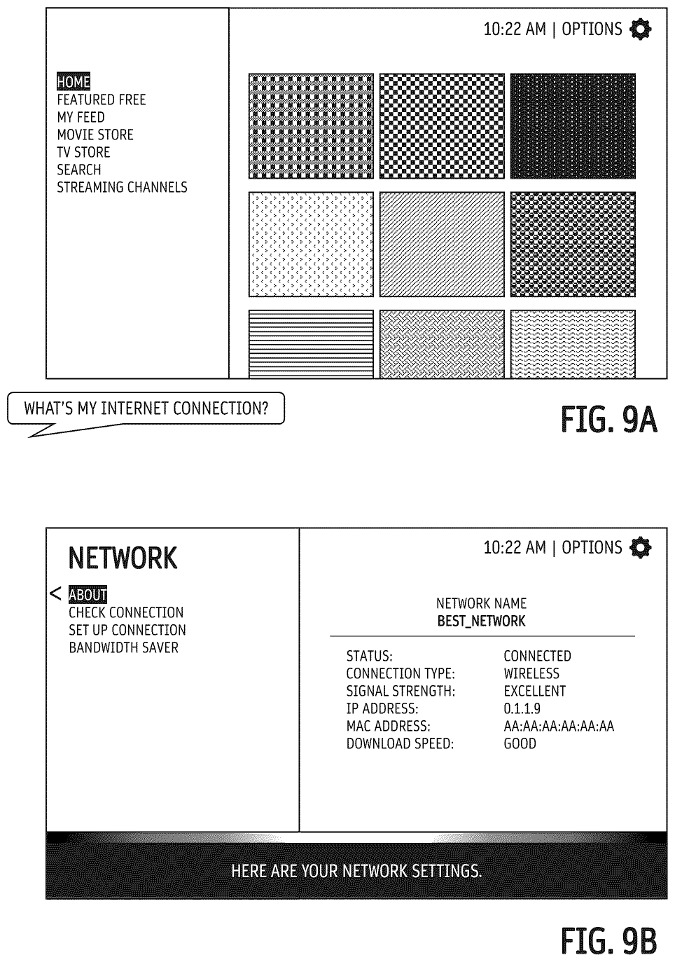

FIG. 9A depicts a graphical user interface when a user makes an utterance, according to some embodiments of the disclosure. For example, a user may make an utterance “what's my Internet connection”. FIG. 9B depicts a graphical user interface displaying a device task page that corresponds to a detected device task intent of the utterance illustrated in FIG. 9A, according to some embodiments of the disclosure. Following method 700, the graphical user interface is updated as depicted in FIG. 9B to display a device task page for viewing network details and a message “here are your network settings” is displayed in a countdown heads-up display.

Referring back to FIG. 7, in some cases, 702 may include determining, based on the output of the device task intent understanding model, that the user utterance corresponds to a first detected device task intent and a second detected device task intent. This means that the utterance may correspond to multiple (overlapping) intents, where the intents may have high probabilities or confidence levels. 702 may include determining, based on the output of the device task intent understanding model, that both a first detected device task intent and a second detected device task intent has a confidence level that exceeds a moderate confidence threshold (and other intents do not have confidence levels that exceed that high confidence threshold). In some cases, 702 may include determining that the user utterance corresponds to one or more further detected device task intents. The determination takes method 700 via the “NO” path to 710.

In 710, multiple choices are displayed to the user. For example, 710 may include determining a first device task page that corresponds to the first detected device task intent and a second device task page that corresponds to the second detected device task intent based on a set of deep links that maps different device task intents to different device task pages. 710 may include updating the graphical user interface to display a first selectable link to the first device task page and a second selectable link to the second device task page. The graphical user interface may request or ask the user to select from the multiple choices/options. The multiple choices may be displayed in a disambiguation heads-up display.

In 712, a user selection of one of the choices/options is received. A user may use a remote (or voice) to indicate a selection of one of the choices/options. A user may select a choice using a remote or cursor to confirm or select the choice among the multiple choices. A user may say the choice to confirm or select the choice among the multiple choices.

In 714, in response to receiving the selection, the graphical user interface changes to go to the destination page corresponding to the selection. For example, 714 may include in response to receiving a user selection of the first selectable link, updating the graphical user interface to display the first device task page. In some embodiments, 714 may proceed to 708 to display a message.

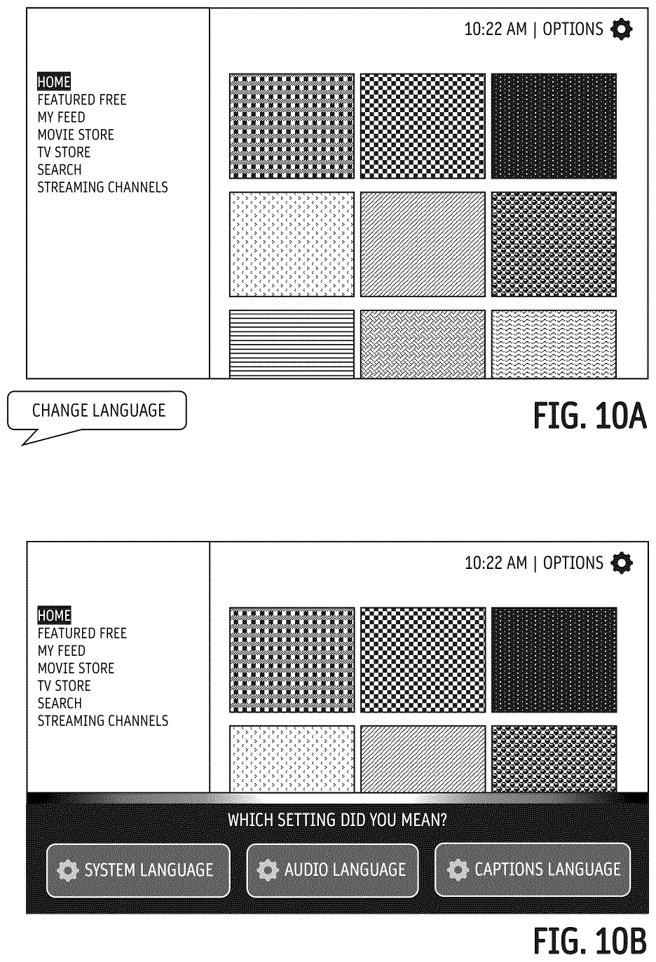

FIG. 10A depicts a graphical user interface when a user makes an utterance, according to some embodiments of the disclosure. For example, a user may make an utterance “change language”. FIG. 10B depicts a graphical user interface displaying options for going to different pages corresponding to different detected device task intents of the utterance illustrated in FIG. 10A, according to some embodiments of the disclosure. Following method 700, the graphical user interface is updated as depicted in FIG. 10B to display multiple options, e.g., “system language”, “audio language”, and “captions language”, in a disambiguation heads-up display along with a message, e.g., “which setting did you mean?”. A user can select one of the options to proceed to a corresponding device task page corresponding to the option.

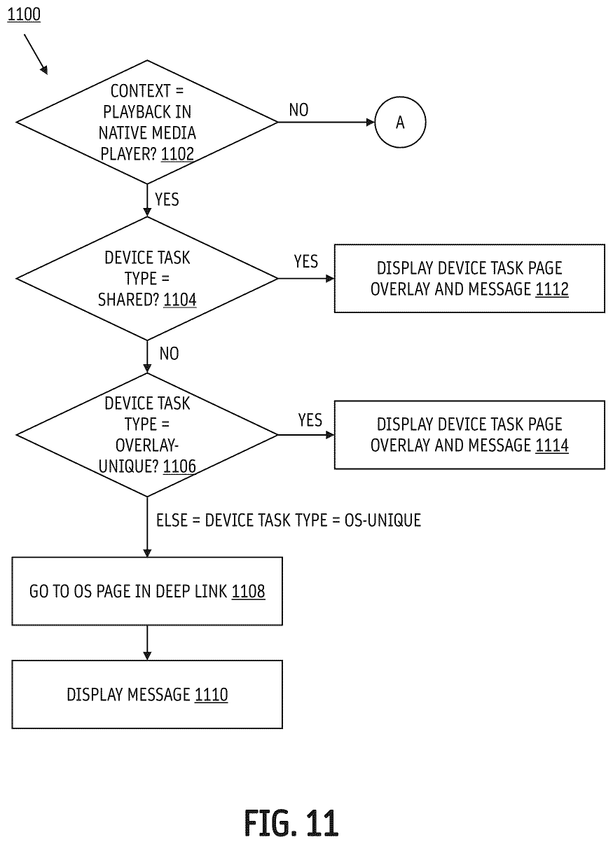

As discussed previously, context and/or device task type can be a consideration when updating the graphical user interface. For example, during media playback (e.g., user is playing a video), special handling can be implemented to handle changing the graphical user interface differently for different device task intent types. While many device task intents can be accomplished or found in the operating system task tree (the operating system settings menu), some device task intents can be accomplished or found in the overlay task tree during media playback (the overlay settings menu). Some device task intents are shared or found in both the operating system task tree and the overlay task tree. Such device task intents can appear in both menus. Examples include accessibility settings, captioning track, audio track, screen reader settings, picture settings, etc. Some device task intents are unique to the operating system task tree (and not found in the overlay task tree). Examples include network settings, add audio device, etc. Some device task intents are unique to the overlay task tree (and not found in the operating system task tree). Examples include sound mode, volume mode, picture mode, etc. An overlay settings menu differs from the operating system settings menu in that the overlay settings menu can be overlayed on top of the media content on a portion of the graphical user interface during media playback (user can press [*] button on the remote device to bring up the overlay settings menu during media playback), and using the operating system menu may cause the media playback to exit to the operating system settings menu. In some cases, some device task intents are unique to the third-party media application in playback mode. Examples include settings relating to the audio track and/or captions. The third-party media application settings menu is separate from the operating system menu and the overlay settings menu. FIGS. 11-20 illustrate exemplary methods for updating graphical user interfaces with special handling based on context and/or device task type.

FIG. 11 depicts a flow diagram illustrating method 1100 for changing the graphical user interface based on a context of the user device, according to some embodiments of the disclosure. Method 1100 may be implemented by handling logic 606 of voice for device tasks application 240 of FIG. 6 (e.g., context dependent and device task type dependent handling 664).

In 1102, the user device state is analyzed to determine whether a context of the user device indicates that a native media player running on the user device is in playback mode. For instance, a trailer video may be played using a native media player as a user is using the native user application of the user device. If the context is that a native media playing running on the user device is in playback mode, method 1100 proceeds via the “YES” path to operations that include updating the graphical user interface in accordance with a type of a detected device task intent, the type being one of: found in both an operating system task tree and an overlay task tree, unique to the operating system task tree, and unique to the overlay task tree. Otherwise, method 1100 proceeds to “A”.

In 1104, it is determined whether the detected device task intent is shared or found in both the operating system task tree and the overlay task tree. If the detected device task intent is shared or found in both the operating system task tree and the overlay task tree, method 1100 proceeds via the “YES” path to 1112. Otherwise, method 1100 proceeds to 1106.

In 1112, a device task page overlay that corresponds to the detected device task intent in the overlay task tree is determined based on a set of deep links that maps different device task intents to different device task pages. The device task page overlay is displayed by updating the graphical user interface accordingly. In some embodiments, updating the graphical user interface further includes displaying a message in a region of the graphical user interface, the message indicating that the detected device task intent can be performed or found on the device task page overlay.

In 1106, it is determined whether the detected device task intent is unique to the overlay task tree. If the detected device task intent is unique to the overlay task tree, method 1100 proceeds via the “YES” path to 1114. Otherwise (the detected device task intent is unique to the operating system task tree), method 1100 proceeds to 1108.

In 1112, a device task page overlay that corresponds to the detected device task intent in the overlay task tree is determined based on a set of deep links that maps different device task intents to different device task pages. The device task page overlay is displayed by updating the graphical user interface accordingly. In some embodiments, updating the graphical user interface further includes displaying a message in a region of the graphical user interface, the message indicating that the detected device task intent can be performed or found on the device task page overlay.

In 1108, a device task page that corresponds to the detected device task intent in the operating system task tree is determined based on a set of deep links that maps different device task intents to different device task pages. The device task page in the operating system task tree is displayed to update the graphical user interface accordingly. In 1110, updating the graphical user interface further includes displaying a message in a region of the graphical user interface, the message indicating that the detected device task intent can be performed or found on the device task page overlay.

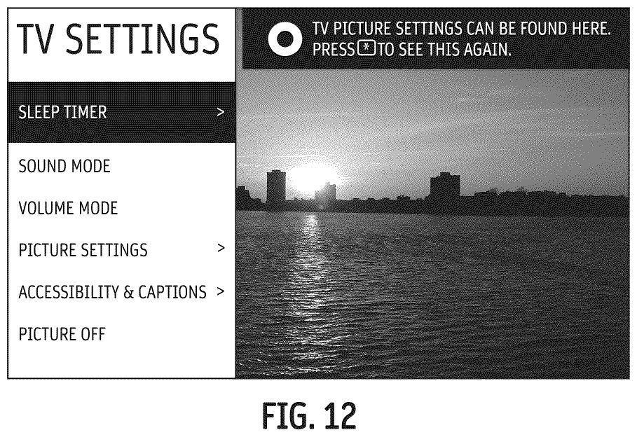

FIG. 12 depicts a graphical user interface displaying a device task page overlay, according to some embodiments of the disclosure. The example illustrates the graphical user interface being updated by following operations of method 1100. Specifically, the graphical user interface illustrates displaying a device task page overlay and a message according to 1112 or 1114 of FIG. 11. The device task page overlay is shown in a left hand side portion of the graphical user interface, overlaying media playback.

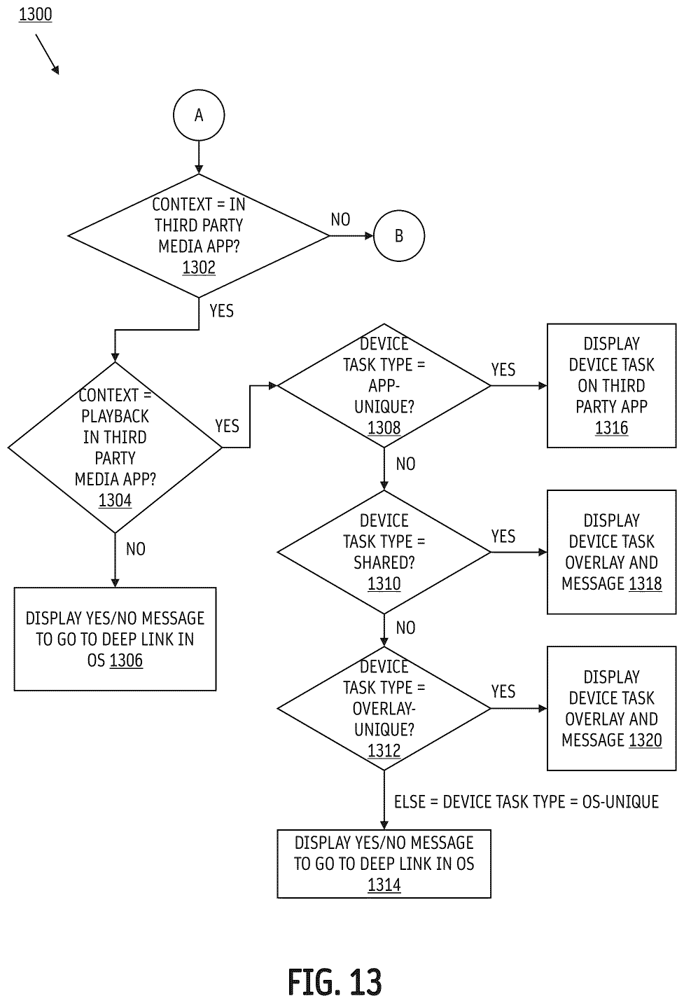

FIG. 13 depicts a flow diagram illustrating method 1300 for changing the graphical user interface based on a context of the user device, according to some embodiments of the disclosure. Method 1300 may be implemented by handling logic 606 of voice for device tasks application 240 of FIG. 6 (e.g., context dependent and device task type dependent handling 664). Method 1300 may follow “A” of FIG. 11.

In 1302, the user device state is analyzed to determine whether a context of the user device indicates that a third-party media application running on the user device is in use (the third-party media application is the active (foreground) application, or the user is actively interacting with the third-party media application). If the context is that a third-party media application running on the user device is in use, method 1300 proceeds via the “YES” path. Otherwise, method 1300 proceeds to “B”

In 1304, the user device state is analyzed to determine whether a context of the user device indicates that a third-party media application running on the user device is in use and whether it is in playback mode or not. For instance, a user may be browsing for content in a third-party media application (not in playback mode). A user may be playing media content in a third-party media application (in playback mode). If the context is that a third-party media application running on the user device is in use but is not in playback mode, method 1300 proceeds via the “NO” path to 1306. If the context is that a third-party media application running on the user device is in use but is in playback mode, method 1300 proceeds via the “YES” path to operations that include updating the graphical user interface in accordance with a type of a detected device task intent, the type being one of: the type being one of: unique to the third-party media application in playback mode, found in both an operating system task tree and an overlay task tree, unique to the operating system task tree, and unique to the overlay task tree.

In 1306, a device task page that corresponds to a detected device task intent is determined based on a set of deep links that maps different device task intents to different device task pages. The graphical user interface is updated to display a yes option to go to the device task page and a no option to not go to the device task page.

In 1308, it is determined whether the detected device task intent is unique to the third-party media application in playback mode. If the detected device task intent is unique to the third-party media application in playback mode, method 1300 proceeds via the “YES” path to 1316. Otherwise, method 1300 proceeds to 1310.

In 1316, a device task page in the third-party media application that corresponds to the detected device task intent is determined based on a set of deep links that maps different device task intents to different device task pages. The graphical user interface is updated by displaying the device task page in the third-party media application.

In 1310, it is determined whether the detected device task intent is shared or found in both the operating system task tree and the overlay task tree. If the detected device task intent is shared or found in both the operating system task tree and the overlay task tree, method 1300 proceeds via the “YES” path to 1318. Otherwise, method 1300 proceeds to 1312.

In 1318, it is determined that the detected device task intent is found in both the operating system task tree and the overlay task tree. A device task page overlay that corresponds to the detected device task intent in the overlay task tree is determined based on a set of deep links that maps different device task intents to different device task pages. The graphical user interface is updated to display the device task page overlay. Optionally, a message can be displayed in a region of the graphical user interface, the message indicating that the detected device task intent can be performed or found on the device task page overlay. An exemplary graphical user interface updated according to 1318 is depicted in FIG. 12.

In 1312, it is determined whether the detected device task intent is unique to the overlay task tree. If the detected device task intent is unique to the overlay task tree, method 1300 proceeds via the “YES” path to 1320. Otherwise (the detected device task intent is unique to the operating system task tree), method 1300 proceeds to 1314.

1320 may be performed similarly to 1318. An exemplary graphical user interface updated according to 1320 is depicted in FIG. 12.

In 1314, it is determined that the detected device task intent is unique to the operating system task tree. A device task page that corresponds to a detected device task intent is determined based on a set of deep links that maps different device task intents to different device task pages. The graphical user interface is updated to display a yes option to go to the device task page and a no option to not go to the device task page.

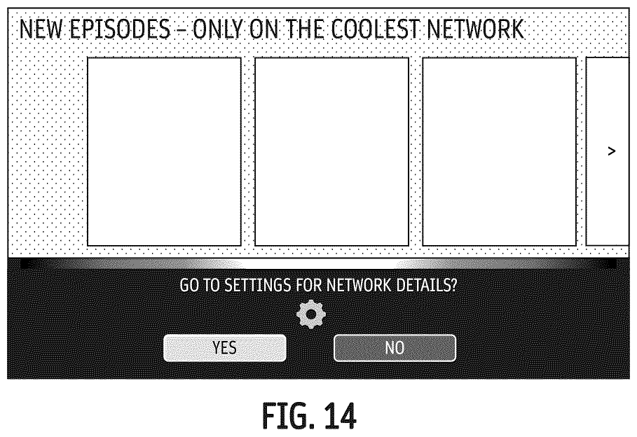

FIG. 14 depicts a graphical user interface displaying a yes option and a no option, according to some embodiments of the disclosure. The example illustrates the graphical user interface being updated by following operations of method 1300. Specifically, the graphical user interface illustrates displaying a yes/no option in a confirmation heads-up display according to 1306 of FIG. 13. The yes/no option is displayed on top of the third-party application that is not in playback mode.

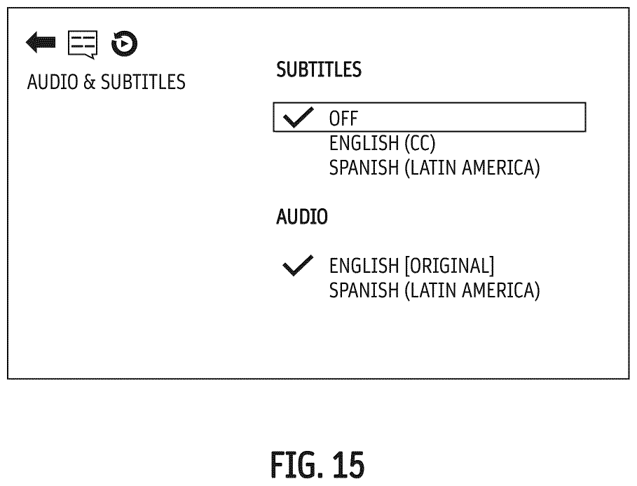

FIG. 15 depicts a graphical user interface displaying device task page in the third-party media application, according to some embodiments of the disclosure. The example illustrates the graphical user interface being updated by following operations of method 1300. Specifically, the graphical user interface illustrates displaying the device task page in the third-party media application according to 1316 of FIG. 13.

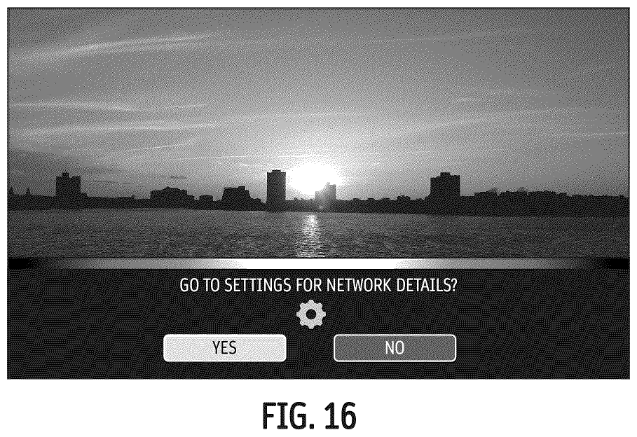

FIG. 16 depicts a graphical user interface displaying a yes option and a no option, according to some embodiments of the disclosure. The example illustrates the graphical user interface being updated by following operations of method 1300. Specifically, the graphical user interface illustrates displaying a yes/no option in a confirmation heads-up display according to 1314 of FIG. 13. The yes/no option is displayed on top of the third-party application that is in playback mode.

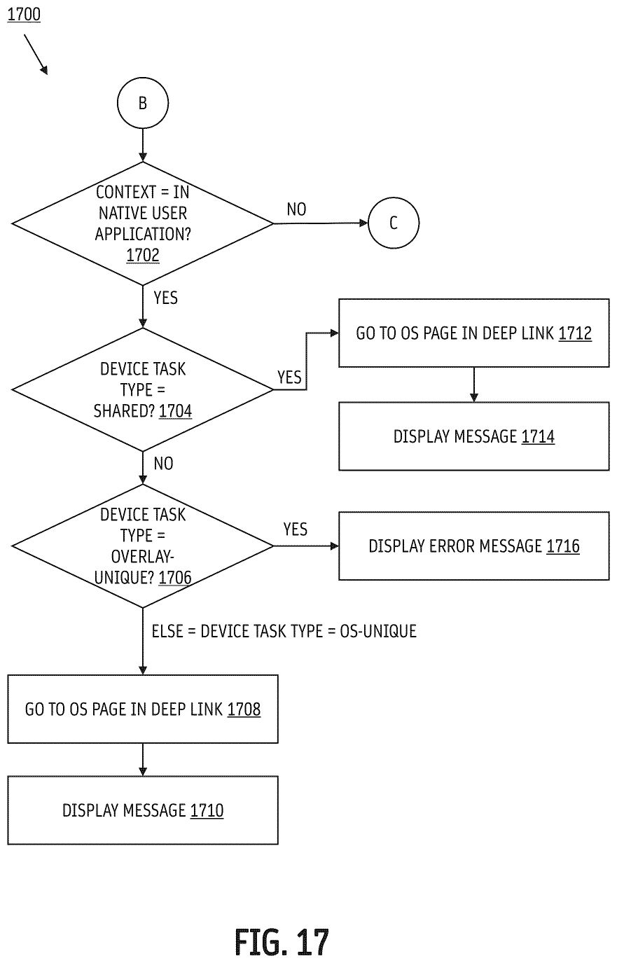

FIG. 17 depicts a flow diagram illustrating method 1700 for changing the graphical user interface based on a context of the user device, according to some embodiments of the disclosure. Method 1700 may be implemented by handling logic 606 of voice for device tasks application 240 of FIG. 6 (e.g., context dependent and device task type dependent handling 664). Method 1700 may follow “B” of FIG. 13.

In 1702, the user device state is analyzed to determine whether a context of the user device indicates that a native user application running on the user device is in use but is not in playback mode. For instance, a user may be browsing through applications in the native user application. If the context is that a native user application running on the user device is in use but is not in playback mode, method 1700 proceeds via the “YES” path to operations for updating the graphical user interface in accordance with a type of a detected device task intent, the type being one of: found in both an operating system task tree and an overlay task tree, unique to the operating system task tree, and unique to the overlay task tree. Otherwise, method 1700 proceeds to “C”.

In 1704, it is determined whether the detected device task intent is shared or found in both the operating system task tree and the overlay task tree. If the detected device task intent is shared or found in both the operating system task tree and the overlay task tree, method 1700 proceeds via the “YES” path to 1712. Otherwise, method 1700 proceeds to 1706.

In 1712, it is determined that the detected device task intent is found in both the operating system task tree and the overlay task tree. A device task page that corresponds to the detected device task intent in the operating system task tree is determined based on a set of deep links that maps different device task intents to different device task pages. The graphical user interface is updated to display the device task page in the operating system task tree. In 1714, the graphical user interface can be optionally updated to display a message in a region of the graphical user interface, the message indicating that the detected device task intent can be performed or found on the device task page. An exemplary graphical user interface updated according to 1712 and 1714 is depicted in FIGS. 8B and 9B.

In 1706, it is determined whether the detected device task intent is unique to the overlay task tree. If the detected device task intent is unique to the overlay task tree, method 1700 proceeds via the “YES” path to 1716. Otherwise (the detected device task intent is unique to the operating system task tree), method 1700 proceeds to 1708.

In 1716, it is determined that the detected device task intent is unique to the overlay task tree. The graphical user interface is updated to display an error message in a region of the graphical user interface, the error message indicating that the detected device task intent is not available.

In 1708, it is determined that the detected device task intent is unique to the operating system task tree. A device task page that corresponds to a detected device task intent is determined based on a set of deep links that maps different device task intents to different device task pages. The graphical user interface is updated to display a yes option to go to the device task page and a no option to not go to the device task page.

1708 may be performed similarly to 1712. 1710 may be performed similarly to 1714. An exemplary graphical user interface updated according to 1708 and 1710 is depicted in FIGS. 8B and 9B.

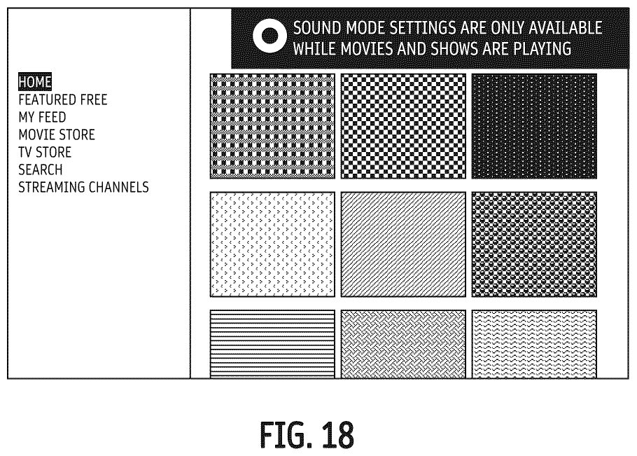

FIG. 18 depicts a graphical user interface displaying an error message, according to some embodiments of the disclosure. The example illustrates the graphical user interface being updated by following operations of method 1700. Specifically, the graphical user interface illustrates displaying the error message indicating that the detected device task intent is not available according to 1716 of FIG. 17.

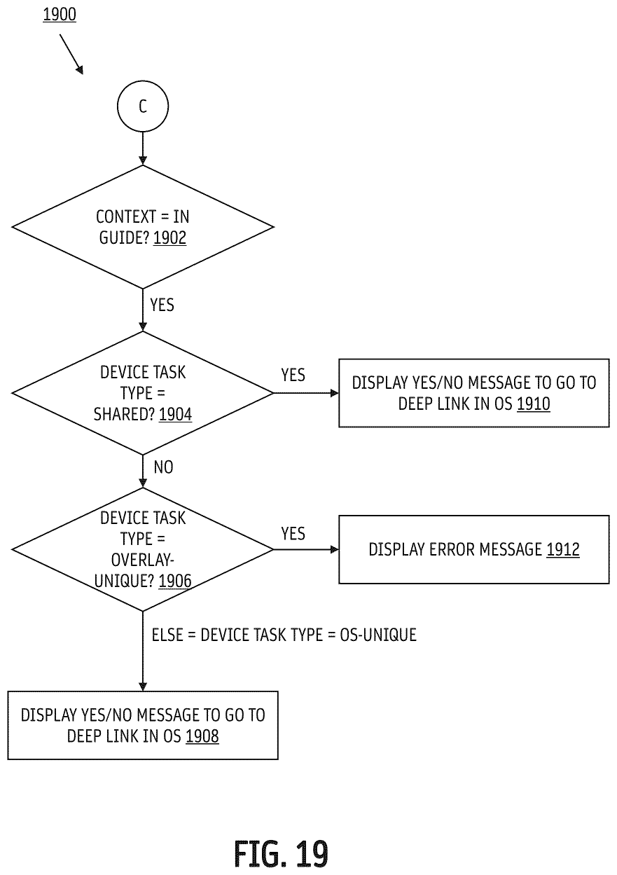

FIG. 19 depicts a flow diagram illustrating method 1900 for changing the graphical user interface based on a context of the user device, according to some embodiments of the disclosure. Method 1900 may be implemented by handling logic 606 of voice for device tasks application 240 of FIG. 6 (e.g., context dependent and device task type dependent handling 664). Method 1900 may follow “B” of FIG. 17.

In 1902, the user device state is analyzed to determine whether a context of the user device indicates that an electronic program guide running on the user device is in use. For instance, a user may be scrolling through the guide and showtimes. If the context is that an electronic program guide running on the user device is in use, method 1900 proceeds via the “YES” path to operations for updating the graphical user interface in accordance with a type of a detected device task intent, the type being one of: found in both an operating system task tree and an overlay task tree, unique to the operating system task tree, and unique to the overlay task tree. Otherwise, method 1900 may enter into an error handling process to log the error and display a generic error message to the user.

In 1904, it is determined whether the detected device task intent is shared or found in both the operating system task tree and the overlay task tree. If the detected device task intent is shared or found in both the operating system task tree and the overlay task tree, method 1900 proceeds via the “YES” path to 1910. Otherwise, method 1900 proceeds to 1906.

In 1910, it is determined that the detected device task intent is found in both the operating system task tree and the overlay task tree. A device task page that corresponds to the detected device task intent in the operating system task tree is determined based on a set of deep links that maps different device task intents to different device task pages. The graphical user interface is updated to display a yes option to go to the device task page and a no option to not go to the device task page, e.g., as a confirmation heads-up display. An exemplary graphical user interface updated according to 1904 is illustrated in FIG. 16 (except that the heads-up display would be displayed over an electronic program guide instead of media playback screen).

In 1906, it is determined whether the detected device task intent is unique to the overlay task tree. If the detected device task intent is unique to the overlay task tree, method 1900 proceeds via the “YES” path to 1912. Otherwise (the detected device task intent is unique to the operating system task tree), method 1900 proceeds to 1908.

In 1912, it is determined that the detected device task intent is unique to the overlay task tree. The graphical user interface is updated to display an error message in a region of the graphical user interface, the error message indicating that the detected device task intent is not available.

In 1908, it is determined that the detected device task intent is unique to the operating system task tree. 1908 may be performed similarly to 1910. An exemplary graphical user interface updated according to 1908 is illustrated in FIG. 16 (except that the heads-up display would be displayed over an electronic program guide instead of media playback screen).

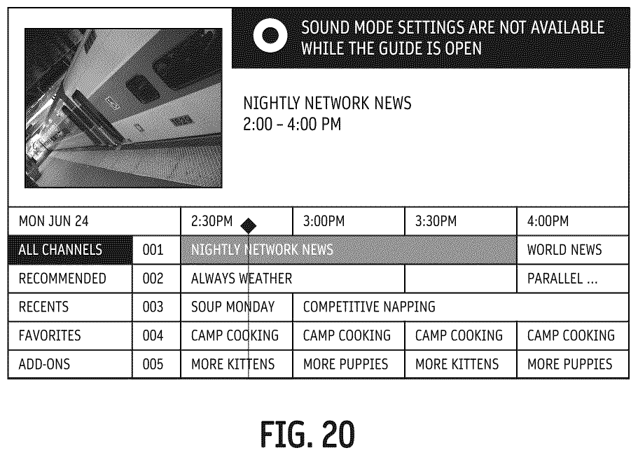

FIG. 20 depicts a graphical user interface displaying an error message, according to some embodiments of the disclosure. The example illustrates the graphical user interface being updated by following operations of method 1900. Specifically, the graphical user interface illustrates displaying the error message indicating that the detected device task intent is not available according to 1912 of FIG. 19.

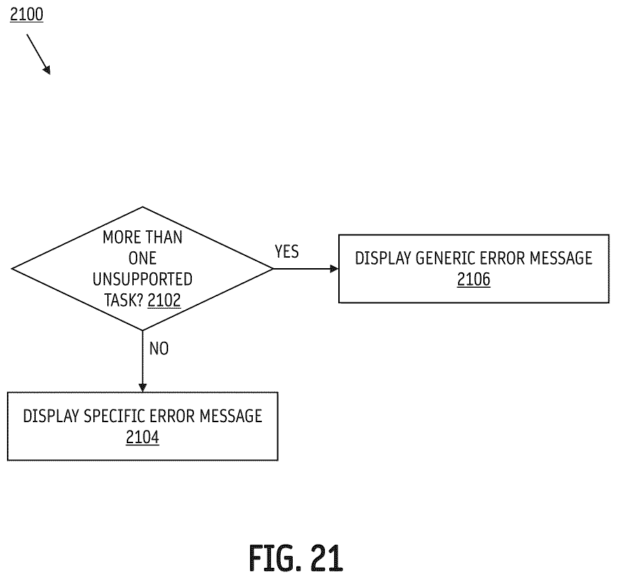

FIG. 21 depicts a flow diagram illustrating method 2100 for handling one or more unsupported device tasks, according to some embodiments of the disclosure. Method 2100 may be implemented by handling logic 606 of voice for device tasks application 240 of FIG. 6 (e.g., device task unsupported messaging 666). Method 2100 may be triggered or performed when there is at least one unsupported device task intents in the output from the device task intent understanding model.

In 2102, it is determined whether there are more than one unsupported device task intents in the model output from the device task intent understanding model. If there are more than one unsupported device task intents, method 2100 follows the “YES” path to 2106. If there is only one unsupported device task intent, method 2100 follows the “NO” path to 2104.

In 2104, it is determined that the one or more detected device task intents include a detected device task intent that is unsupported by the user device. The graphical user interface is updated to display a specific error message in a region of the graphical user interface. The specific error message may include an error message indicating that the detected device task intent is not available on the user device.

In 2106, it is determined that the one or more detected device task intents include a plurality of detected device task intents that are unsupported by the user device. The graphical user interface is updated to display a generic error message in a region of the graphical user interface. The generic error message may include an error message indicating that performing a device task is not possible on the user device.

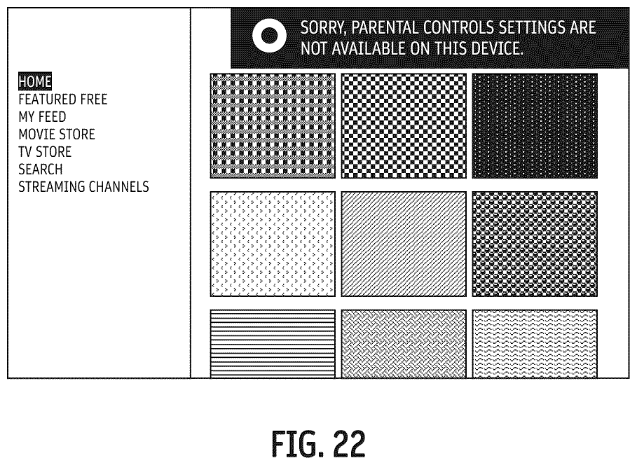

FIG. 22 depicts a graphical user interface displaying an error message, according to some embodiments of the disclosure. The example illustrates the graphical user interface being updated by following operations of method 2100. Specifically, the graphical user interface illustrates displaying a specific error message indicating that the detected device task intent is not available according to 2104 of FIG. 21.

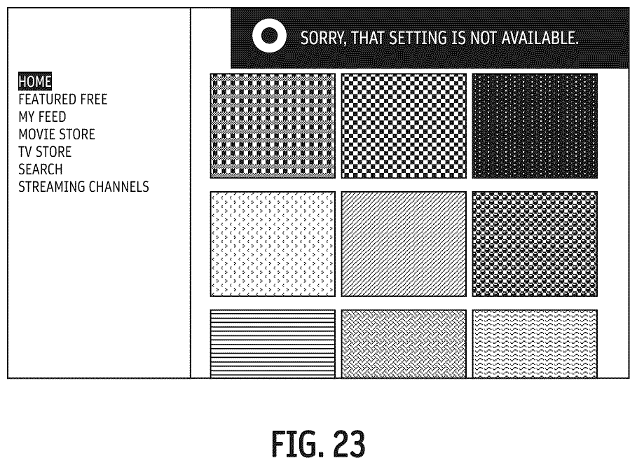

FIG. 23 depicts a graphical user interface displaying an error message, according to some embodiments of the disclosure. The example illustrates the graphical user interface being updated by following operations of method 2100. Specifically, the graphical user interface illustrates displaying a specific error message indicating that the detected device task intent is not available according to 2106 of FIG. 21.

FIG. 24 depicts a flow diagram illustrating method 2400 for managing voice hints, according to some embodiments of the disclosure. Method 2400 may be implemented by handling logic 606 of voice for device tasks application 240 of FIG. 6 (e.g., user event driven voice hinting 810).

In 2402, user interactions are tracked to detect whether a user enters a device task page through an operating system task tree (or menu) or overlay task tree (or menu), e.g., using a remote device. If user interactions indicate the user has entered a device task page through the menu using a remote device, method 2400 may proceed via the “YES” path to operations relating to voice hint suppression. Otherwise, method 2400 continues to track user interactions via the “NO” path looping back to 2402.

In 2404, it is determined whether user device was setup less than X number of days ago. If yes, method 2400 may proceed to 2410 via the “YES” path. Otherwise, method 2400 proceeds to 2406.

In 2410, display of message having a voice hint is suppressed in response to determining that the user device was setup less than X number of days ago.

In 2406, it is determined whether the voice hint was displayed less than Y number of days ago. If yes, method 2400 may proceed to 2412 via the “YES” path. Otherwise, method 2400 proceeds to 2408.

In 2410, display of message having the voice hint is suppressed in response to determining that voice hint was displayed less than Y number of days ago.

In 2408, a specific voice hint may be displayed. For example, the graphical user interface may be updated to display a message having a voice hint indicating that voice can be used to perform a device task.

In some embodiments, suppression of voice hint (e.g., 2410 and 2412) and one or more checks to determine whether to suppress voice hint (e.g., 2404 and 2406) are optional.

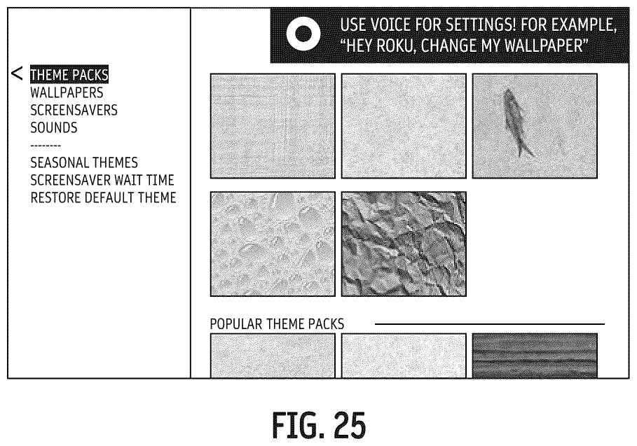

FIG. 25 depicts a graphical user interface displaying a message having a voice hint, according to some embodiments of the disclosure. The example illustrates the graphical user interface being updated by following operations of method 2400. Specifically, the graphical user interface illustrates displaying a voice hint according to 2408 of FIG. 24.

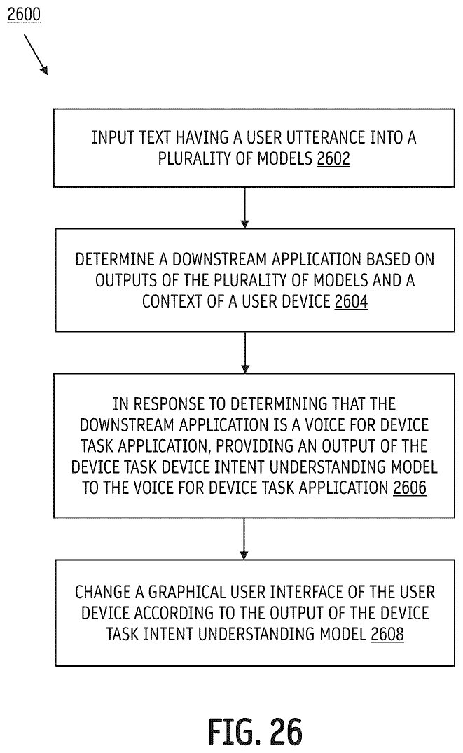

FIG. 26 depicts a flow diagram illustrating method 2600 for enabling users to use voice to assist in performing device tasks, according to some embodiments of the disclosure. Method 2600 may be implemented by handling logic 606 of voice for device tasks application 240 of FIG. 6.

In 2602, text having a user utterance is input into a plurality of models. The plurality of models can include a content search intent understanding model, a channel control intent understanding model, and a device task intent understanding model (e.g., as illustrated in FIG. 4).

In 2604, a downstream application is determined based on outputs of the plurality of models and a context of a user device.

In 2606, in response to determining that the downstream application is a voice for device task application, an output of the device task intent understanding model is provided to the voice for device task application. The output of the device task intent understanding model can include one or more detected device task intents.

In 2608, a graphical user interface of the user device is changed according to the output of the device task intent understanding model.

### Displaying Messages to End Users Using Heads-Up Displays

One user interface behavior includes displaying a countdown head-up display (HUD). The countdown HUD may be displayed for a certain amount of time and goes away after the certain amount of time. The countdown HUD may be displayed when the action is destructive.

Another user interface behavior may include displaying a confirmation HUD. The confirmation HUD may include one or more options for a user to select or confirm. The confirmation HUD may be displayed when the action is destructive.

Another user interface behavior may include a disambiguation HUD. The disambiguation HUD may include one or more options corresponding to one or more detected device task intents. The disambiguation HUD may be generated based on the output of the device task intent understanding model and optionally the output of one or more models in the federation of models. The disambiguation HUD enables a user to see the different options and make a user decision on which option to pursue.

Herein, heads-up displays may have different sizes (some may occupy a larger region on the screen than others), depending on the functionality intended. A mini-heads-up display refers to a message overlay displayed in a small region on the screen. Heads-up displays may be permanently displayed until a user action is taken. Heads-up displays may be a countdown heads-up display where the heads-up display is shown on the screen for a period of time and goes away after the period of time. Heads-up displays may have different functionalities, such as informational, disambiguation, confirmation, warning, etc. Heads-up displays may display messages. Heads-up displays may display different content.

### Exemplary Computing Device

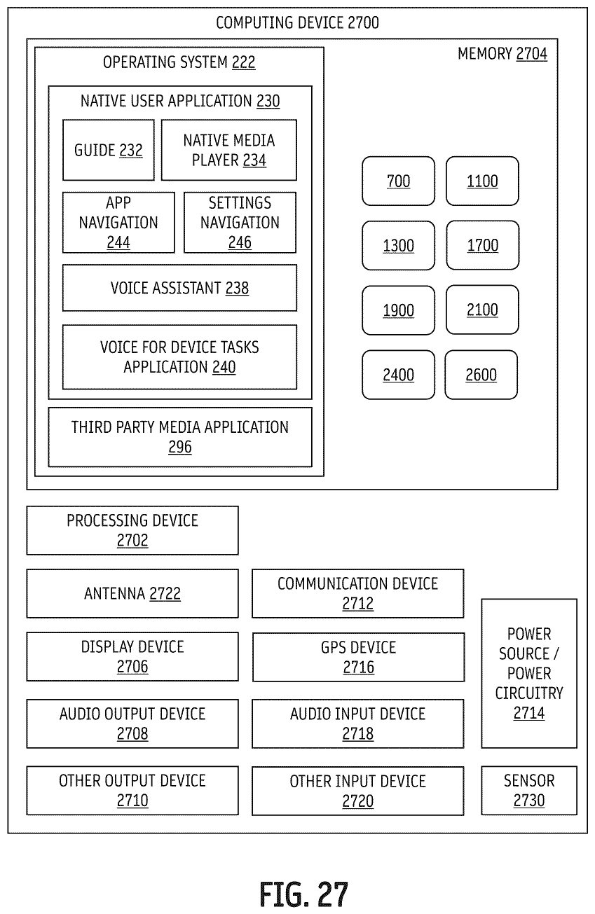

FIG. 27 is a block diagram of an exemplary computing device 2700, according to some embodiments of the disclosure. One or more computing devices 2700 may be used to implement the functionalities described with the FIGS. and herein. A number of components are illustrated in FIG. 27 as included in computing device 2700, but any one or more of these components may be omitted or duplicated, as suitable for the application. In some embodiments, some or all of the components included in the computing device 2700 may be attached to one or more motherboards. In some embodiments, some or all of these components are fabricated onto a single system on a chip (SoC) die. Additionally, in various embodiments, the computing device 2700 may not include one or more of the components illustrated in FIG. 27, and the computing device 2700 may include interface circuitry for coupling to the one or more components. For example, the computing device 2700 may not include a display device 2706, and may include display device interface circuitry (e.g., a connector and driver circuitry) to which a display device 2706 may be coupled. In another set of examples, the computing device 2700 may not include an audio input device 2718 or an audio output device 2708 and may include audio input or output device interface circuitry (e.g., connectors and supporting circuitry) to which an audio input device 2718 or audio output device 2708 may be coupled.

The computing device 2700 may include a processing device 2702 (e.g., one or more processing devices, one or more of the same type of processing device, one or more of different types of processing device). The processing device 2702 may include electronic circuitry that process electronic data from data storage elements (e.g., registers, memory, resistors, capacitors, quantum bit cells) to transform that electronic data into other electronic data that may be stored in registers and/or memory. Examples of processing device 2702 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 2700 may include a memory 2704, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 2704 includes one or more non-transitory computer-readable storage media. In some embodiments, memory 2704 may include memory that shares a die with the processing device 2702.

In some embodiments, memory 2704 includes one or more non-transitory computer-readable media storing instructions executable to perform operations described herein (e.g., receiving and processing audio signals having one or more utterances, natural language processing to determine intent or device task an end user wishes to complete, disambiguation of device tasks, ranking of device tasks, generating UI/UX output, generating voice HUD Text, going to deep links, etc.). Memory 2704 may store instructions that encode one or more exemplary parts, components, or modules. In some embodiments, memory 2704 may store instructions that encode operating system 222 or one or more components illustrated with operating system 222. The instructions stored in the one or more non-transitory computer-readable media may be executed by processing device 2702. In some embodiments, memory 2704 may store instructions that cause the processing device 2702 to execute one or more methods (or one or more operations thereof), such as method 700, method 1100, method 1300, method 1700, method 1900, method 2100, method 2400, and method 2600. In some embodiments, memory 2704 may store data, e.g., data structures, binary data, bits, metadata, files, blobs, etc., as described herein.

In some embodiments, the computing device 2700 may include a communication device 2712 (e.g., one or more communication devices). For example, the communication device 2712 may be configured for managing wired and/or wireless communications for the transfer of data to and from the computing device 2700. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 2712 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 2712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 2712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 2712 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 2712 may operate in accordance with other wireless protocols in other embodiments. The computing device 2700 may include an antenna 2722 to facilitate wireless communications and/or to receive other wireless communications (such as radio frequency transmissions). The computing device 2700 may include receiver circuits and/or transmitter circuits. In some embodiments, the communication device 2712 may manage wired communications, such as electrical, optical, or any other suitable communication protocols (e.g., the Ethernet). As noted above, the communication device 2712 may include multiple communication chips. For instance, a first communication device 2712 may be dedicated to shorter-range wireless communications such as Wi-Fi or Bluetooth, and a second communication device 2712 may be dedicated to longer-range wireless communications such as global positioning system (GPS), EDGE, GPRS, CDMA, WiMAX, LTE, EV-DO, or others. In some embodiments, a first communication device 2712 may be dedicated to wireless communications, and a second communication device 2712 may be dedicated to wired communications.

The computing device 2700 may include power source/power circuitry 2714. The power source/power circuitry 2714 may include one or more energy storage devices (e.g., batteries or capacitors) and/or circuitry for coupling components of the computing device 2700 to an energy source separate from the computing device 2700 (e.g., DC power, AC power, etc.).

The computing device 2700 may include a display device 2706 (or corresponding interface circuitry, as discussed above). The display device 2706 may include any visual indicators, such as a heads-worn display, a computer monitor, a projector, a touchscreen display, a LCD, a light-emitting diode display, or a flat panel display, for example.

The computing device 2700 may include an audio output device 2708 (or corresponding interface circuitry, as discussed above). The audio output device 2708 may include any device that generates an audible indicator, such as speakers, headsets, or earbuds, for example.

The computing device 2700 may include an audio input device 2718 (or corresponding interface circuitry, as discussed above). The audio input device 2718 may include any device that generates a signal representative of a sound, such as microphones, microphone arrays, or digital instruments (e.g., instruments having a musical instrument digital interface (MIDI) output). In some embodiments, the audio input device 2718 is a remote control having a microphone. In some embodiments, the audio input device 2718 is a mobile device communicably connected with computing device 2700, where the mobile device has a microphone.

The computing device 2700 may include a GPS device 2716 (or corresponding interface circuitry, as discussed above). The GPS device 2716 may be in communication with a satellite-based system and may receive a location of the computing device 2700, as known in the art.

The computing device 2700 may include a sensor 2730 (or one or more sensors). The computing device 2700 may include corresponding interface circuitry, as discussed above). Sensor 2730 may sense physical phenomenon and translate the physical phenomenon into electrical signals that can be processed by, e.g., processing device 2702. Examples of sensor 2730 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 2700 may include another output device 2710 (or corresponding interface circuitry, as discussed above). Examples of the other output device 2710 may include an audio codec, a video codec, a printer, a wired or wireless transmitter for providing information to other devices, haptic output device, gas output device, vibrational output device, lighting output device, home automation controller, or an additional storage device.

The computing device 2700 may include another input device 2720 (or corresponding interface circuitry, as discussed above). Examples of the other input device 2720 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2700 may have any desired form factor, such as a handheld or mobile computer system (e.g., a cell phone, a smart phone, a mobile Internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a television, a media player, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 2700 may be any other electronic device that processes data.

### Select Examples

Example 1 provides a method, including inputting text having a user utterance into a plurality of models, the plurality of models including a content search intent understanding model, a channel control intent understanding model, and a device task intent understanding model; determining a downstream application based on outputs of the plurality of models and a context of a user device; in response to determining that the downstream application is a voice for device task application, providing an output of the device task intent understanding model to the voice for device task application, the output of the device task intent understanding model including one or more detected device task intents; and changing a graphical user interface of the user device according to the output of the device task intent understanding model.

Example 2 provides the method of example 1, further including determining, based on the output of the device task intent understanding model, that the user utterance corresponds to a first detected device task intent; and determining a first device task page that corresponds to the first detected device task intent based on a set of deep links that maps different device task intents to different device task pages; where changing the graphical user interface includes updating the graphical user interface to display the first device task page.

Example 3 provides the method of example 2, where changing the graphical user interface further includes displaying a message in a region of the first device task page, the message indicating that a first detected device task intent can be performed or found on the first device task page.

Example 4 provides the method of any one of examples 1-3, further including determining, based on the output of the device task intent understanding model, that the user utterance corresponds to a first detected device task intent and a second detected device task intent; and determining a first device task page that corresponds to the first detected device task intent and a second device task page that corresponds to the second detected device task intent based on a set of deep links that maps different device task intents to different device task pages; where changing the graphical user interface includes updating the graphical user interface to display a first selectable link to the first device task page and a second selectable link to the second device task page.

Example 5 provides the method of example 4, where changing the graphical user interface further includes in response to receiving a user selection of the first selectable link, updating the graphical user interface to display the first device task page.

Example 6 provides the method of any one of examples 1-5, where changing the graphical user interface includes determining that a native media player running on the user device is in playback mode; and updating the graphical user interface in accordance with a type of a detected device task intent, the type being one of: found in both an operating system task tree and an overlay task tree, unique to the operating system task tree, and unique to the overlay task tree.

Example 7 provides the method of example 6, where updating the graphical user interface includes determining that the detected device task intent is found in both the operating system task tree and the overlay task tree; determining a device task page overlay that corresponds to the detected device task intent in the overlay task tree based on a set of deep links that maps different device task intents to different device task pages; and display the device task page overlay.

Example 8 provides the method of example 7, where updating the graphical user interface further includes displaying a message in a region of the graphical user interface, the message indicating that the detected device task intent can be performed or found on the device task page overlay.

Example 9 provides the method of example 6, where updating the graphical user interface includes determining that the detected device task intent is unique to the overlay task tree; determining a device task page overlay that corresponds to the detected device task intent in the overlay task tree based on a set of deep links that maps different device task intents to different device task pages; and display the device task page overlay.

Example 10 provides the method of example 9, where updating the graphical user interface further includes displaying a message in a region of the graphical user interface, the message indicating that the detected device task intent can be performed or found on the device task page overlay.

Example 11 provides the method of example 6, where updating the graphical user interface includes determining that the detected device task intent is unique to the operating system task tree; determining a device task page that corresponds to the detected device task intent in the operating system task tree based on a set of deep links that maps different device task intents to different device task pages; and display the device task page in the operating system task tree.

Example 12 provides the method of example 11, where updating the graphical user interface further includes displaying a message in a region of the graphical user interface, the message indicating that the detected device task intent can be performed or found on the device task page.

Example 13 provides the method of any one of examples 1-5, where changing the graphical user interface includes determining that a third-party media application running on the user device is in use but is not in playback mode; determining a device task page that corresponds to a detected device task intent based on a set of deep links that maps different device task intents to different device task pages; and updating the graphical user interface to display a yes option to go to the device task page and a no option to not go to the device task page.

Example 14 provides the method of any one of examples 1-5, where changing the graphical user interface includes determining that a third-party media application running on the user device is in use and is in playback mode; and updating the graphical user interface in accordance with a type of a detected device task intent, the type being one of: unique to the third-party media application in playback mode, found in both an operating system task tree and an overlay task tree, unique to the operating system task tree, and unique to the overlay task tree.

Example 15 provides the method of example 14, where updating the graphical user interface includes determining that the detected device task intent is unique to the third-party media application in playback mode; determining a device task page in the third-party media application that corresponds to the detected device task intent based on a set of deep links that maps different device task intents to different device task pages; and display the device task page in the third-party media application.

Example 16 provides the method of example 14, where updating the graphical user interface includes determining that the detected device task intent is found in both the operating system task tree and the overlay task tree; determining a device task page overlay that corresponds to the detected device task intent in the overlay task tree based on a set of deep links that maps different device task intents to different device task pages; and displaying the device task page overlay.

Example 17 provides the method of example 16, where updating the graphical user interface further includes displaying a message in a region of the graphical user interface, the message indicating that the detected device task intent can be performed or found on the device task page overlay.

Example 18 provides the method of example 14, where updating the graphical user interface includes determining that the detected device task intent is unique to the overlay task tree; determining a device task page overlay that corresponds to the detected device task intent in the overlay task tree based on a set of deep links that maps different device task intents to different device task pages; and displaying the device task page overlay.

Example 19 provides the method of example 18, where updating the graphical user interface further includes displaying a message in a region of the graphical user interface, the message indicating that the detected device task intent can be performed or found on the device task page overlay.

Example 20 provides the method of example 19, where updating the graphical user interface includes determining that the detected device task intent is unique to the operating system task tree; determining a device task page that corresponds to a detected device task intent based on a set of deep links that maps different device task intents to different device task pages; and updating the graphical user interface to display a yes option to go to the device task page and a no option to not go to the device task page.

Example 21 provides the method of any one of examples 1-5, where changing the graphical user interface includes determining that a native user application running on the user device is in use but is not in playback mode; and updating the graphical user interface in accordance with a type of a detected device task intent, the type being one of: found in both an operating system task tree and an overlay task tree, unique to the operating system task tree, and unique to the overlay task tree.

Example 22 provides the method of example 21, where: determining that the detected device task intent is found in both the operating system task tree and the overlay task tree; determining a device task page that corresponds to the detected device task intent in the operating system task tree based on a set of deep links that maps different device task intents to different device task pages; and displaying the device task page in the operating system task tree.

Example 23 provides the method of example 22, where updating the graphical user interface further includes displaying a message in a region of the graphical user interface, the message indicating that the detected device task intent can be performed or found on the device task page.

Example 24 provides the method of example 21, where updating the graphical user interface includes determining that the detected device task intent is unique to the overlay task tree; and displaying an error message in a region of the graphical user interface, the error message indicating that the detected device task intent is not available.

Example 25 provides the method of example 21, where updating the graphical user interface includes determining that the detected device task intent is unique to the operating system task tree; determining a device task page that corresponds to the detected device task intent in the operating system task tree based on a set of deep links that maps different device task intents to different device task pages; and displaying the device task page in the operating system task tree.

Example 26 provides the method of example 22, where updating the graphical user interface further includes displaying a message in a region of the graphical user interface, the message indicating that the detected device task intent can be performed or found on the device task page.

Example 27 provides the method of any one of examples 1-5, where changing the graphical user interface includes determining that an electronic program guide running on the user device is in use; and updating the graphical user interface in accordance with a type of a detected device task intent, the type being one of: found in both an operating system task tree and an overlay task tree, unique to the operating system task tree, and unique to the overlay task tree.

Example 28 provides the method of example 27, where updating the graphical user interface further includes determining that the detected device task intent is found in both the operating system task tree and the overlay task tree; determining a device task page that corresponds to the detected device task intent in the operating system task tree based on a set of deep links that maps different device task intents to different device task pages; and updating the graphical user interface to display a yes option to go to the device task page and a no option to not go to the device task page.

Example 29 provides the method of example 27, where updating the graphical user interface further includes determining that the detected device task intent is unique to the overlay task tree; and displaying an error message in a region of the graphical user interface, the error message indicating that the detected device task intent is not available.

Example 30 provides the method of example 27, where updating the graphical user interface includes determining that the detected device task intent is unique to the operating system task tree; determining a device task page that corresponds to a detected device task intent in the operating system task tree based on a set of deep links that maps different device task intents to different device task pages; and updating the graphical user interface to display a yes option to go to the device task page and a no option to not go to the device task page.

Example 31 provides the method of any one of examples 1-30, further including determining that the one or more detected device task intents include a detected device task intent that is unsupported by the user device; where updating the graphical user interface further includes displaying an error message in a region of the graphical user interface, the error message indicating that the detected device task intent is not available on the user device.

Example 32 provides the method of any one of examples 1-31, further including determining that the one or more detected device task intents include a plurality of detected device task intents that are unsupported by the user device; where updating the graphical user interface further includes displaying an error message in a region of the graphical user interface.

Example 33 provides the method of any one of examples 1-32, further including detecting a user enters a device task page through an operating system task tree or an overlay task tree; and suppress displaying a message having a voice hint in response to determining that the user device was setup less than a number of days ago.

Example 34 provides the method of any one of examples 1-33, further including detecting a user enters a device task page through an operating system task tree or an overlay task tree; and suppress displaying a message having a voice hint in response to determining that the voice hint was displayed less than a number of days ago.

Example 35 provides the method of any one of examples 1-34, further including detecting a user enters a device task page through an operating system task tree or an overlay task tree; and displaying a message having a voice hint indicating that voice can be used to perform a device task.

Example 36 provides an apparatus including means to perform a method according to any one of examples 1-35.

Example 37 provides a computer program product including instructions which, when executed by a processor, cause the processor to perform a method according to any one of examples 1-35.

Example 38 provides machine-readable storage including machine-readable instructions, when executed, cause a computer to implement a method according to any one of examples 1-35.

Example 39 provides a computer program including instructions which, when the computer program is executed by a processing device, cause the processing device to carry out a method according to any one of examples 1-35.

Example 40 provides one or more non-transitory computer-readable media storing instructions that, when executed by one or more processors, cause the one or more processors to perform a method according to any one of examples 1-35.

Example 41 provides an apparatus, including one or more processors; and one or more non-transitory computer-readable media storing instructions that, when executed by the one or more processors, cause the one or more processors to perform a method according to any one of examples 1-35.

### Variations and Other Notes

Although the operations of the example methods shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
inputting text having a user utterance into a plurality of models, the plurality of models including a content search intent understanding model, a channel control intent understanding model, and a device task intent understanding model;
determining a downstream application based on outputs of the plurality of models and a context of a user device;
in response to determining that the downstream application is a voice for device task application, providing an output of the device task intent understanding model to the voice for device task application, the output of the device task intent understanding model comprising one or more detected device task intents; and
changing a graphical user interface of the user device according to the output of the device task intent understanding model.

2. The method of claim 1, further comprising:
determining, based on the output of the device task intent understanding model, that the user utterance corresponds to a first detected device task intent; and
determining a first device task page that corresponds to the first detected device task intent based on a set of deep links that maps different device task intents to different device task pages;
wherein changing the graphical user interface comprises updating the graphical user interface to display the first device task page.

3. The method of claim 2, wherein changing the graphical user interface further comprises:
displaying a message in a region of the first device task page, the message indicating that a first detected device task intent can be performed or found on the first device task page.

4. The method of claim 1, further comprising:
determining, based on the output of the device task intent understanding model, that the user utterance corresponds to a first detected device task intent and a second detected device task intent; and
determining a first device task page that corresponds to the first detected device task intent and a second device task page that corresponds to the second detected device task intent based on a set of deep links that maps different device task intents to different device task pages;
wherein changing the graphical user interface comprises updating the graphical user interface to display a first selectable link to the first device task page and a second selectable link to the second device task page.

5. The method of claim 4, wherein changing the graphical user interface further comprises:
in response to receiving a user selection of the first selectable link, updating the graphical user interface to display the first device task page.

6. The method of claim 1, wherein changing the graphical user interface comprises:
determining that a native media player running on the user device is in playback mode; and
updating the graphical user interface in accordance with a type of a detected device task intent, the type being one of: found in both an operating system task tree and an overlay task tree, unique to the operating system task tree, and unique to the overlay task tree.

7. The method of claim 1, wherein changing the graphical user interface comprises:
determining that a third-party media application running on the user device is in use but is not in playback mode;
determining a device task page that corresponds to a detected device task intent based on a set of deep links that maps different device task intents to different device task pages; and
updating the graphical user interface to display a yes option to go to the device task page and a no option to not go to the device task page.

8. The method of claim 1, wherein changing the graphical user interface comprises:
determining that a third-party media application running on the user device is in use and is in playback mode; and
updating the graphical user interface in accordance with a type of a detected device task intent, the type being one of: unique to the third-party media application in playback mode, found in both an operating system task tree and an overlay task tree, unique to the operating system task tree, and unique to the overlay task tree.

9. The method of claim 1, wherein changing the graphical user interface comprises:
determining that a native user application running on the user device is in use but is not in playback mode; and
updating the graphical user interface in accordance with a type of a detected device task intent, the type being one of: found in both an operating system task tree and an overlay task tree, unique to the operating system task tree, and unique to the overlay task tree.

10. The method of claim 1, wherein changing the graphical user interface comprises:
determining that an electronic program guide running on the user device is in use; and
updating the graphical user interface in accordance with a type of a detected device task intent, the type being one of: found in both an operating system task tree and an overlay task tree, unique to the operating system task tree, and unique to the overlay task tree.

11. The method of claim 1, further comprising:
determining that the one or more detected device task intents include a detected device task intent that is unsupported by the user device;
wherein updating the graphical user interface further comprises displaying an error message in a region of the graphical user interface, the error message indicating that the detected device task intent is not available on the user device.

12. The method of claim 1, further comprising:
determining that the one or more detected device task intents include a plurality of detected device task intents that are unsupported by the user device;
wherein updating the graphical user interface further comprises displaying an error message in a region of the graphical user interface.

13. The method of claim 1, further comprising:
detecting a user enters a device task page through an operating system task tree or an overlay task tree; and
suppress displaying a message having a voice hint in response to determining that the user device was setup less than a number of days ago.

14. The method of claim 1, further comprising:
detecting a user enters a device task page through an operating system task tree or an overlay task tree; and
suppress displaying a message having a voice hint in response to determining that the voice hint was displayed less than a number of days ago.

15. The method of claim 1, further comprising:
detecting a user enters a device task page through an operating system task tree or an overlay task tree; and
displaying a message having a voice hint indicating that voice can be used to perform a device task.

16. One or more non-transitory computer-readable media storing instructions that, when executed by one or more processors, cause the one or more processors to:
input text having a user utterance into a plurality of models, the plurality of models including a content search intent understanding model, a channel control intent understanding model, and a device task intent understanding model;
determine a downstream application based on outputs of the plurality of models and a context of a user device;
in response to determining that the downstream application is a voice for device task application, provide an output of the device task intent understanding model to the voice for device task application, the output of the device task intent understanding model comprising one or more detected device task intents; and
change a graphical user interface of the user device according to the output of the device task intent understanding model.

17. The one or more non-transitory computer-readable media of claim 16, the instructions further cause the one or more processors to:
determine, based on the output of the device task intent understanding model, that the user utterance corresponds to a first detected device task intent; and
determine a first device task page that corresponds to the first detected device task intent based on a set of deep links that maps different device task intents to different device task pages;
wherein changing the graphical user interface comprises updating the graphical user interface to display the first device task page.

18. The one or more non-transitory computer-readable media of claim 17, wherein changing the graphical user interface further comprises:
displaying a message in a region of the first device task page, the message indicating that a first detected device task intent can be performed or found on the first device task page.

19. An apparatus, comprising:
one or more processors; and
one or more non-transitory computer-readable media storing instructions that, when executed by the one or more processors, cause the one or more processors to:
input text having a user utterance into a plurality of models, the plurality of models including a content search intent understanding model, a channel control intent understanding model, and a device task intent understanding model;
determine a downstream application based on outputs of the plurality of models and a context of a user device;
in response to determining that the downstream application is a voice for device task application, provide an output of the device task intent understanding model to the voice for device task application, the output of the device task intent understanding model comprising one or more detected device task intents; and
change a graphical user interface of the user device according to the output of the device task intent understanding model.

20. The apparatus of claim 19, wherein the instructions further cause the one or more processors to:
determine, based on the output of the device task intent understanding model, that the user utterance corresponds to a first detected device task intent and a second detected device task intent; and
determine a first device task page that corresponds to the first detected device task intent and a second device task page that corresponds to the second detected device task intent based on a set of deep links that maps different device task intents to different device task pages;
wherein changing the graphical user interface comprises updating the graphical user interface to display a first selectable link to the first device task page and a second selectable link to the second device task page, and in response to receiving a user selection of the first selectable link, updating the graphical user interface to display the first device task page.
